(19) United States
(12) Patent Application Publication
(10) Pub. No.: US 2025/0193824 A1
(43) Pub. Date: Jun. 12, 2025

(54) METHOD OF USER EQUIPMENT (UE), UE, METHOD OF COMMUNICATION APPARATUS AND COMMUNICATION APPARATUS

(71) Applicant: NEC Corporation, Minato-ku, Tokyo (JP)

(72) Inventors: Kundan TIWARI, Sitamarhi (IN); Toshiyuki TAMURA, Tokyo (JP); Iskren IANEV, Reading (GB)

(73) Assignee: NEC Corporation, Minato-ku, Tokyo (JP)

(21) Appl. No.: 18/845,482

(22) PCT Filed: Mar. 17, 2023
(86) PCT No.: PCT/JP2023/010547

§ 371 Date: Sep. 10, 2024

(30) Foreign Application Priority Data
Mar. 24, 2022 (IN) 202211016659

(51) Int. Cl. H04W 60/00

(52) U.S. Cl. CPC H04W 60/00

(57) ABSTRACT

There are many ambiguous descriptions in 3GPP specification(s) how to handle the NSSRG feature.

A method of a user equipment (UE) includes communicating with a communication apparatus. The method includes sending a Registration Request message. The Registration Request message includes Requested Network Slice Selection Assistance Information (NSSAI). The Requested NSSAI includes first Single Network Slice Selection Assistance Information (S-NSSAI). The first S-NSSAI and second S-NSSAI in Pending NSSAI are associated with at least one common Network Slice Simultaneous Registration Group (NSSRG) value.

### TECHNICAL FIELD

The present disclosure relates to a method of a user equipment (UE), a UE, a method of a communication apparatus and a communication apparatus.

### BACKGROUND ART

The NSSRG (Network Slice Simultaneous Registration Group) is introduced to the 5GS in release 17. The NSSRG feature provides 3GPP operators a mechanism for limiting a combination of network slices to be registered at the same time.

### CITATION LIST

### Non Patent Literature

[NPL 1] 3GPP TR 21.905: “Vocabulary for 3GPP Specifications”. V17.1.0 (2021-12)
[NPL 2] 3GPP TS 23.501: “System architecture for the 5G System (5GS)”. V17.3.0 (2021-12)
[NPL 3] 3GPP TS 23.502: “Procedures for the 5G System (5GS)”. V17.3.0 (2021-12)
[NPL 4] 3GPP TS 23.503: “Policy and charging control framework for the 5G System (5GS) Stage 2”. V17.3.0 (2021-12)

### SUMMARY OF INVENTION

### Technical Problem

However, there are many ambiguous descriptions in 3GPP specification(s) how to handle the NSSRG feature.

For example, this disclosure provides solution for this problem.

### Solution to Problem

In an aspect of the present disclosure, a method of a user equipment (UE) includes communicating with a communication apparatus and sending a Registration Request message. The Registration Request message includes Requested Network Slice Selection Assistance Information (NSSAI). The Requested NSSAI includes first Single Network Slice Selection Assistance Information (S-NSSAI). The first S-NSSAI and second S-NSSAI in Pending NSSAI are associated with at least one common Network Slice Simultaneous Registration Group (NSSRG) value.

In an aspect of the present disclosure, a user equipment (UE) includes means for communicating with a communication apparatus and means for sending a Registration Request message. The Registration Request message includes Requested Network Slice Selection Assistance Information (NSSAI). The Requested NSSAI includes first Single Network Slice Selection Assistance Information (S-NSSAI). The first S-NSSAI and second S-NSSAI in Pending NSSAI are associated with at least one common Network Slice Simultaneous Registration Group (NSSRG) value.

In an aspect of the present disclosure, a method of a communication apparatus includes communicating with a user equipment (UE). The method includes sending a message. The message includes Allowed Network Slice Selection Assistance Information (NSSAI). The Allowed NSSAI includes first Single Network Slice Selection Assistance Information (S-NSSAI). The first S-NSSAI and second S-NSSAI in Pending NSSAI are associated with at least one common Network Slice Simultaneous Registration Group (NSSRG) value.

In an aspect of the present disclosure, a communication apparatus includes means for communicating with a user equipment (UE). The communication apparatus includes means for sending a message. The message includes Allowed Network Slice Selection Assistance Information (NSSAI). The Allowed NSSAI includes first Single Network Slice Selection Assistance Information (S-NSSAI). The first S-NSSAI and second S-NSSAI in Pending NSSAI are associated with at least one common Network Slice Simultaneous Registration Group (NSSRG) value.

In an aspect of the present disclosure, a method of a communication apparatus includes sending a first message including Pending Network Slice Selection Assistance Information (NSSAI). The Pending NSSAI includes first Single Network Slice Selection Assistance Information (S-NSSAI). The method includes receiving a registration request message including Requested NSSAI. The Requested NSSAI includes second S-NSSAI. The method includes checking whether the first S-NSSAI and the second S-NSSAI are associated with at least one common Network Slice Simultaneous Registration Group (NSSRG) value. The method includes sending a second message including Configured NSSAI in case where the first S-NSSAI and the second S-NSSAI are not associated with the at least one common NSSRG value.

In an aspect of the present disclosure, a communication apparatus includes means for sending a first message including Pending Network Slice Selection Assistance Information (NSSAI). The Pending NSSAI includes first Single Network Slice Selection Assistance Information (S-NSSAI). The communication apparatus includes means for receiving a registration request message including Requested NSSAI. The Requested NSSAI includes second S-NSSAI. The communication apparatus includes means for checking whether the first S-NSSAI and the second S-NSSAI are associated with at least one common Network Slice Simultaneous Registration Group (NSSRG) value. The communication apparatus includes means for sending a second message including Configured NSSAI in case where the first S-NSSAI and the second S-NSSAI are not associated with the at least one common NSSRG value.

### BRIEF DESCRIPTION OF DRAWINGS

FIG. 1 is a signaling diagram of a First example of the First Aspect (NSSRG checking with S-NSSAI(s) in the Pending NSSAI in the UE).

FIG. 2 is a signaling diagram of a Second example of the First Aspect (NSSRG checking with S-NSSAI(s) in the Pending NSSAI in the AMF).

FIG. 3 is a signaling diagram of a First example of the Second Aspect (NSSRG checking with S-NSSAI(s) in the Pending NSSAI for other access in the AMF).

FIG. 4 is a diagram illustrating a system overview.

FIG. 5 is a block diagram illustrating a User Equipment (UE).

FIG. 6 is a block diagram illustrating an (R)AN node.

FIG. 7 is a diagram illustrating System overview of (R)AN node based on O-RAN architecture.

FIG. 8 is a block diagram illustrating a Radio Unit (RU).

FIG. 9 is a block diagram illustrating a Distributed Unit (DU).

FIG. 10 is a block diagram illustrating a Centralized Unit (CU).

FIG. 11 is a block diagram illustrating an Access and Mobility Management Function (AMF).

FIG. 12 is a block diagram illustrating a Policy Control Function (PCF).

FIG. 13 is a block diagram illustrating an Authentication Server Function (AUSF).

FIG. 14 is a block diagram illustrating a Unified Data Management (UDM).

FIG. 15 is a block diagram illustrating a Network Slice-Specific Authentication and Authorization Function (NSSAAF).

### DESCRIPTION OF EMBODIMENTS

### Abbreviations

For the purposes of the present document, the abbreviations given in NPL 1 and the following apply. An abbreviation defined in the present document takes precedence over the definition of the same abbreviation, if any, in NPL 1.

| | |
|---|---|
| 4G-GUTI | 4G Globally Unique Temporary UE Identity |
| 5GC | 5G Core Network |
| 5GLAN | 5G Local Area Network |
| 5GS | 5G System |
| 5G-AN | 5G Access Network |
| 5G-AN PDB | 5G Access Network Packet Delay Budget |
| 5G-EIR | 5G-Equipment Identity Register |
| 5G-GUTI | 5G Globally Unique Temporary Identifier |
| 5G-BRG | 5G Broadband Residential Gateway |
| 5G-CRG | 5G Cable Residential Gateway |
| 5G GM | 5G Grand Master |
| 5G-RG | 5G Residential Gateway |
| 5G-S-TMSI | 5G S-Temporary Mobile Subscription Identifier |
| 5G VN | 5G Virtual Network |
| 5QI | 5G QoS Identifier |
| AF | Application Function |
| AMF | Access and Mobility Management Function |
| AMF-G | Geographically selected Access and Mobility |
| | Management Function |
| AMF-NG | Non-Geographically selected Access and Mobility |
| | Management Function |
| ANDSF | Access Network Discovery and Selection Function |
| AS | Access Stratum |
| ATSSS | Access Traffic Steering, Switching, Splitting |
| ATSSS-LL | ATSSS Low-Layer |
| AUSF | Authentication Server Function |
| AUTN | Authentication token |
| BCCH | Broadcast Control Channel |
| BMCA | Best Master Clock Algorithm |
| BSF | Binding Support Function |
| CAG | Closed Access Group |
| CAPIF | Common API Framework for 3GPP northbound |
| | APIs |
| CHF | Charging Function |
| CN PDB | Core Network Packet Delay Budget |
| CP | Control Plane |
| DAPS | Dual Active Protocol Stacks |
| DL | Downlink |
| DN | Data Network |
| DNAI | DN Access Identifier |
| DNN | Data Network Name |
| DRX | Discontinuous Reception |
| DS-TT | Device-side TSN translator |
| ePDG | evolved Packet Data Gateway |
| EBI | EPS Bearer Identity |
| EPS | Evolved Packet System |
| EUI | Extended Unique Identifier |
| FAR | Forwarding Action Rule |
| FN-BRG | Fixed Network Broadband RG |
| FN-CRG | Fixed Network Cable RG |
| FN-RG | Fixed Network RG |
| FQDN | Fully Qualified Domain Name |
| GFBR | Guaranteed Flow Bit Rate |
| GMLC | Gateway Mobile Location Centre |
| GPSI | Generic Public Subscription Identifier |
| GUAMI | Globally Unique AMF Identifier |
| GUTI | Globally Unique Temporary UE Identity |
| HPLMN | Home Public Land Mobile Network |
| HR | Home Routed (roaming) |
| IAB | Integrated access and backhaul |
| IMEI/TAC | IMEI Type Allocation Code |
| IPUPS | Inter PLMN UP Security |
| I-SMF | Intermediate SMF |
| I-UPF | Intermediate UPF |
| LADN | Local Area Data Network |
| LBO | Local Break Out (roaming) |
| LMF | Location Management Function |
| LoA | Level of Automation |
| LPP | LTE Positioning Protocol |
| LRF | Location Retrieval Function |
| MCC | Mobile country code |
| MCX | Mission Critical Service |
| MDBV | Maximum Data Burst Volume |
| MFBR | Maximum Flow Bit Rate |
| MICO | Mobile Initiated Connection Only |
| MITM | Man In the Middle |
| MNC | Mobile Network Code |
| MPS | Multimedia Priority Service |
| MPTCP | Multi-Path TCP Protocol |
| N3IWF | Non-3GPP InterWorking Function |
| N3GPP | Non-3GPP access |
| N5CW | Non-5G-Capable over WLAN |
| NAI | Network Access Identifier |
| NAS | Non-Access-Stratum |
| NEF | Network Exposure Function |
| NF | Network Function |
| NGAP | Next Generation Application Protocol |
| NID | Network identifier |
| NPN | Non-Public Network |
| NR | New Radio |
| NRF | Network Repository Function |
| NSI ID | Network Slice Instance Identifier |
| NSSAA | Network Slice-Specific Authentication and |
| | Authorization |
| NSSAAF | Network Slice-Specific Authentication and |
| | Authorization Function |
| NSSAI | Network Slice Selection Assistance Information |
| NSSF | Network Slice Selection Function |
| NSSP | Network Slice Selection Policy |
| NSSRG | Network Slice Simultaneous Registration Group |
| NW-TT | Network-side TSN translator |
| NWDAF | Network Data Analytics Function |
| PCF | Policy Control Function |
| PCO | Protocol Configuration Options |
| PDB | Packet Delay Budget |
| PDR | Packet Detection Rule |
| PDU | Protocol Data Unit |
| PEI | Permanent Equipment Identifier |
| PER | Packet Error Rate |
| PFD | Packet Flow Description |
| PLMN | Public Land Mobile Network |
| PNI-NPN | Public Network Integrated Non-Public Network |
| PPD | Paging Policy Differentiation |
| PPF | Paging Proceed Flag |
| PPI | Paging Policy Indicator |
| PSA | PDU Session Anchor |
| PTP | Precision Time Protocol |
| QFI | QoS Flow Identifier |
| QoE | Quality of Experience |
| RACS | Radio Capabilities Signalling optimisation |
| (R)AN | (Radio) Access Network |
| RAT | Radio Access Technology |
| RG | Residential Gateway |
| RIM | Remote Interference Management |
| RQA | Reflective QoS Attribute |
| RQI | Reflective QoS Indication |
| RSN | Redundancy Sequence Number |
| SA NR | Standalone New Radio |
| SBA | Service Based Architecture |
| SBI | Service Based Interface |
| SCP | Service Communication Proxy |
| SD | Slice Differentiator |
| SEAF | Security Anchor Functionality |
| SEPP | Security Edge Protection Proxy |
| SMF | Session Management Function |
| SMSF | Short Message Service Function |
| SN | Sequence Number |
| SN name | Serving Network Name. |
| SNPN | Stand-alone Non-Public Network |
| S-NSSAI | Single Network Slice Selection Assistance |
| | Information |
| SSC | Session and Service Continuity |
| SSCMSP | Session and Service Continuity Mode Selection |
| | Policy |
| SST | Slice/Service Type |
| SUCI | Subscription Concealed Identifier |
| SUPI | Subscription Permanent Identifier |
| SV | Software Version |
| TMSI | Temporary Mobile Subscriber Identity |
| TNAN | Trusted Non-3GPP Access Network |
| TNAP | Trusted Non-3GPP Access Point |
| TNGF | Trusted Non-3GPP Gateway Function |
| TNL | Transport Network Layer |
| TNLA | Transport Network Layer Association |
| TSC | Time Sensitive Communication |
| TSCAI | TSC Assistance Information |
| TSN | Time Sensitive Networking |
| TSN GM | TSN Grand Master |
| TSP | Traffic Steering Policy |
| TT | TSN Translator |
| TWIF | Trusted WLAN Interworking Function |
| UCMFUE | radio Capability Management Function |
| UDM | Unified Data Management |
| UDR | Unified Data Repository |
| UDSF | Unstructured Data Storage Function |
| UE | User Equipment |
| UL | Uplink |
| UL CL | Uplink Classifier |
| UPF | User Plane Function |
| UPSI | UE Policy Section Identifier |
| URLLC | Ultra Reliable Low Latency Communication |
| URRP-AMF | UE Reachability Request Parameter for AMF |
| URSP | UE Route Selection Policy |
| VID | VLAN Identifier |
| VLAN | Virtual Local Area Network |
| VPLMN | Visited Public Land Mobile Network |
| W-5GAN | Wireline 5G Access Network |
| W-5GBAN | Wireline BBF Access Network |
| W-5GCAN | Wireline 5G Cable Access Network |
| W-AGF | Wireline Access Gateway Function |

### Definitions

For the purposes of the present document, the terms and definitions given in NPL 1 and the following apply. A term defined in the present document takes precedence over the definition of the same term, if any, in NPL 1.

### General

Those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the Aspects of the present disclosure so as not to obscure the figures with details that will be readily apparent to those skilled in the art having the benefit of the description herein.

For the purpose of promoting an understanding of the principles of the disclosure, reference will now be made to the Aspect illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or entities or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an Aspect”, “in another Aspect” and similar language throughout this specification may, but not necessarily do, all refer to the same Aspect.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which may be defined to have the following meanings. The singular forms “a”, “an”, and “the” include plural references unless the context clearly dictates otherwise.

As used herein, information is associated with data and knowledge, as data is meaningful information and represents the values attributed to parameters. Further knowledge signifies understanding of an abstract or concrete concept. Note that this example system is simplified to facilitate description of the disclosed subject matter and is not intended to limit the scope of this disclosure. Other devices, systems, and configurations may be used to implement the Aspects disclosed herein in addition to, or instead of, a system, and all such Aspects are contemplated as within the scope of the present disclosure.

Each of Aspects and elements included in each Aspects described below may be implemented independently or in combination with any other. These Aspects include novel characteristics different from one another. Accordingly, these Aspects contribute to achieving objects or solving problems different from one another and contribute to obtaining advantages different from one another.

An example object of this disclosure is to provide a method and apparatus that can solve the above problem.

A method of a user equipment (UE) according to example aspect of this disclosure includes receiving a message including Pending Network Slice Selection Assistance Information (NSSAI). The Pending NSSAI includes first Single Network Slice Selection Assistance Information (S-NSSAI). The method includes checking whether the first S-NSSAI and second S-NSSAI are associated with at least one common Network Slice Simultaneous Registration Group (NSSRG) value in a case where registration procedure using the second S-NSSAI is triggered. The method includes sending a registration request message including the second S-NSSAI in a case where the first S-NSSAI and the second S-NSSAI are associated with the at least one common NSSRG value.

A method of a communication apparatus according to example aspect of this disclosure includes sending a first message including Pending Network Slice Selection Assistance Information (NSSAI). The Pending NSSAI includes first Single Network Slice Selection Assistance Information (S-NSSAI). The method includes receiving a registration request message including Requested NSSAI. The Requested NSSAI includes second S-NSSAI. The method includes checking whether the first S-NSSAI and the second S-NSSAI are associated with at least one common Network Slice Simultaneous Registration Group (NSSRG) value. The method includes sending a second message including Configured NSSAI in case where the first S-NSSAI and the second S-NSSAI are not associated with the at least one common NSSRG value.

A user equipment (UE) according to example aspect of this disclosure includes a memory, and at least one hardware processor coupled to the memory. The at least one hardware processor is configured to receive a message including Pending Network Slice Selection Assistance Information (NSSAI). The Pending NSSAI includes first Single Network Slice Selection Assistance Information (S-NSSAI). The at least one hardware processor is configured to check whether the first S-NSSAI and second S-NSSAI are associated with at least one common Network Slice Simultaneous Registration Group (NSSRG) value in a case where registration procedure using the second S-NSSAI is triggered. The at least one hardware processor is configured to send a registration request message including the second S-NSSAI in a case where the first S-NSSAI and the second S-NSSAI are associated with the at least one common NSSRG value.

A communication apparatus according to example aspect of this disclosure includes a memory, and at least one hardware processor coupled to the memory. The at least one hardware processor is configured to send a first message including Pending Network Slice Selection Assistance Information (NSSAI). The Pending NSSAI includes first Single Network Slice Selection Assistance Information (S-NSSAI). The at least one hardware processor is configured to receive a registration request message including Requested NSSAI. The Requested NSSAI includes second S-NSSAI. The at least one hardware processor is configured to check whether the first S-NSSAI and the second S-NSSAI are associated with at least one common Network Slice Simultaneous Registration Group (NSSRG) value. The at least one hardware processor is configured to send a second message including Configured NSSAI in case where the first S-NSSAI and the second S-NSSAI are not associated with the at least one common NSSRG value.

### <First Aspect>

The NSSRG (Network Slice Simultaneous Registration Group) is introduced to the 5GS in release 17. The NSSRG feature provides 3GPP operator(s) mechanism for limiting a combination of network slices to be registered to the end user at the same time. According to current 3GPP specification(s), the NSSRG information (e.g. information indicating NSSRG or information related to NSSRG) is provided to a UE from 5GC, and the UE chooses the network slice(s) based on the NSSRG information. However, it is not clear in 3GPP specification(s) what the 5GC is supposed to do if the UE holds an old Configured network slice(s) (e.g. old Configured NSSAI) and/or old NSSRG information. In this case, the NSSRG feature does not work properly.

For example, this aspect focuses on an issue when an AMF 70 detects, based on the NSSRG information, that S-NSSAI(s) in Requested NSSAI in a Registration Request message from a UE 3 includes S-NSSAI(s) that is not compatible with S-NSSAI(s) in Pending NSSAI in the AMF 70. For example, this aspect provides solution for this issue.

For example, as the S-NSSAI(s) in the Requested NSSAI and the S-NSSAI(s) in the Pending NSSAI cannot be allowed to be registered at the same time, the AMF 70 detects that at least one of Configured NSSAI and NSSRG information in the UE 3 are not the latest ones. For example, the AMF 70 detects that at least one of the Configured NSSAI and the NSSRG information in the UE 3 are out of date. In this case, the AMF 70 provides at least one of Configured NSSAI and NSSRG information to the UE 3 to refresh data in the UE 3.

For example, this aspect also discloses a method of handling registration procedure in a case where S-NSSAI(s) of the Requested NSSAI in the Registration Request message does not belong to or does not share any common NSSRG value with S-NSSAI(s) in the Pending NSSAI.

For example, this aspect also discloses a method of handling registration procedure in a case where S-NSSAI(s) of the Requested NSSAI in the Registration Request message belongs to or shares at least one common NSSRG value with S-NSSAI(s) in the Pending NSSAI.

### <First Example of the First Aspect: >

A First example of the First Aspect discloses a method where the UE 3 checks whether S-NSSAI(s) in Pending NSSAI and Requested NSSAI in a Registration Request message belong to or share at least one common NSSRG value.

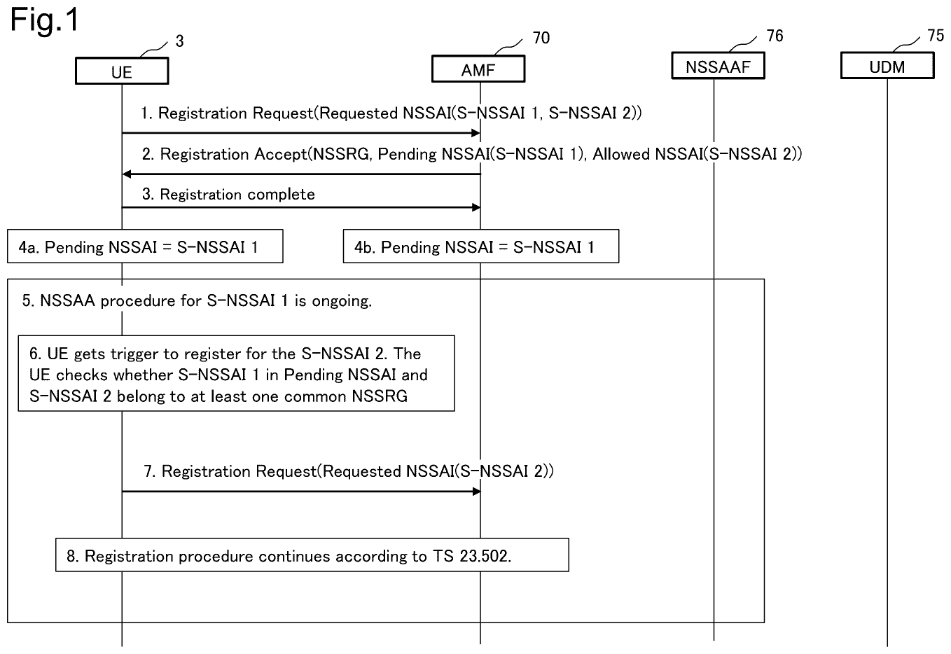

The detailed processes of the First example of the First Aspect are described below, with reference to FIG. 1.
1) The UE 3 is configured to support the NSSRG procedure. The UE 3 initiates registration procedure to register S-NSSAI 1 and S-NSSAI 2 by sending the Registration Request message with Requested NSSAI which is set to the S-NSSAI 1 and the S-NSSAI 2. The Requested NSSAI may include one or more S-NSSAI(s). For example, the S-NSSAI 1 is subject to the NSSAA procedure.
2) When the AMF 70 receives the Registration Request message containing the S-NSSAI 1 and the S-NSSAI 2 in the Requested NSSAI, the AMF 70 identifies that the S-NSSAI 1 is subject to the NSSAA procedure. For example, the AMF 70 may identify that the S-NSSAI 1 is subject to the NSSAA procedure based on local configuration in the AMF 70 or operator's policy or information received from other network node. The AMF 70 marks the S-NSSAI 1 as the Pending NSSAI, the AMF 70 determines that the S-NSSAI 2 is allowed to use for the UE 3, and the AMF 70 sends a Registration Accept message containing the S-NSSAI 1 in the Pending NSSAI and the S-NSSAI 2 in the Allowed NSSAI. The Registration Accept message may contain at least one of Configured NSSAI and NSSRG information as well. The NSSRG information may be information indicating NSSRG or information related to NSSRG. For example, the UE 3 can understand based on the NSSRG information which network slice (e.g. S-NSSAI) belongs to which NSSRG value or NSSRG. For example, the UE 3 can understand based on the NSSRG information which network slice(s) (e.g. S-NSSAI(s)) share to NSSRG value or NSSRG. For example, the UE 3 can understand based on the NSSRG information which network slice (e.g. S-NSSAI) is associated with which NSSRG value or NSSRG. The NSSRG information may be referred to as NSSRG.

The AMF 70 may know that the UE 3 has the Pending NSSAI including the S-NSSAI 1.
3) Upon receiving the Registration Accept message, the UE 3 stores the Pending NSSAI and the Allowed NSSAI. In a case where the Registration Accept message includes at least one the Configured NSSAI and the NSSRG information, the UE 3 stores at least one of the Configured NSSAI and the NSSRG information. The UE 3 sends a Registration Complete message. For example, the UE 3 may send the Registration Complete message in a case where the UE 3 receives the Registration Accept message.
4a) At step 4a, the UE 3 has the S-NSSAI 1 in the Pending NSSAI. For example, the UE 3 may have the Pending NSSAI including the S-NSSAI 1. In addition, for example the UE 3 may have the Allowed NSSAI including the S-NSSAI 2.
4b) At step 4b, the AMF 70 has the S-NSSAI 1 in the Pending NSSAI. For example, the AMF 70 may have the Pending NSSAI including the S-NSSAI 1.
5) The AMF 70 initiates the NSSAA procedure for the S-NSSAI 1 as defined in NPL 3.
6) The UE 3 gets a trigger to register the S-NSSAI 2. The UE 3 checks the NSSRG information whether the S-NSSAI 1 in the Pending NSSAI in the UE 3 and the S-NSSAI 2 share at least one common NSSRG value (e.g. the UE 3 checks whether the S-NSSAI 1 and the S-NSSAI 2 share at least one common NSSRG based on the NSSRG information or the UE 3 checks whether the S-NSSAI 1 and the S-NSSAI 2 belong to at least one common NSSRG value based on the NSSRG information, or the UE 3 checks whether the S-NSSAI 1 and the S-NSSAI 2 belong to at least one common NSSRG based on the NSSRG information). The UE 3 keeps the S-NSSAI 1 in the Pending NSSAI during the NSSAA procedure. The steps 6 to 8 may be performed during the NSSAA procedure for the S-NSSAI 1. The checking whether the S-NSSAI 1 and the S-NSSAI 2 share at least one common NSSRG value may be referred to as checking whether the S-NSSAI 1 and the S-NSSAI 2 are associated with at least one common NSSRG value.
7) If the S-NSSAI 1 in the Pending NSSAI in the UE 3 and the S-NSSAI 2 belong to at least one common NSSRG value (e.g. if the S-NSSAI 1 and the S-NSSAI 2 belong to at least one common NSSRG or if the S-NSSAI 1 and the S-NSSAI 2 share at least one common NSSRG value or if the S-NSSAI 1 and the S-NSSAI 2 share at least one common NSSRG or if the S-NSSAI 1 and the S-NSSAI 2 are associated with at least one common NSSRG value), then the UE 3 initiates registration procedure by sending the Registration Request message including the Requested NSSAI set with the S-NSSAI 2. The UE 3 may initiate the registration procedure by sending the Registration Request message including the Requested NSSAI set with the S-NSSAI 1 and the S-NSSAI 2.

For example, in a case where the S-NSSAI 1 is associated with NSSRG 1 (or NSSRG value 1) and the S-NSSAI 2 is associated with NSSRG 1 (or NSSRG value 1), the UE 3 determines that the S-NSSAI 1 and the S-NSSAI 2 belong to or share or are associated with the common NSSRG (or the common NSSRG value), and initiates the registration procedure by sending the Registration Request message including the Requested NSSAI which includes the S-NSSAI 2.

If the S-NSSAI 1 in the Pending NSSAI in the UE 3 and the S-NSSAI 2 do not belong to a common NSSRG value (e.g. if the S-NSSAI 1 and the S-NSSAI 2 do not belong to a common NSSRG or if the S-NSSAI 1 and the S-NSSAI 2 do not share a common NSSRG value or if the S-NSSAI 1 and the S-NSSAI 2 do not share a common NSSRG or if the S-NSSAI 1 and the S-NSSAI 2 are not associated with any common NSSRG value), then the UE 3 has a few options to take.

For example, in a case where the S-NSSAI 1 is associated with NSSRG 1 (or NSSRG value 1) and the S-NSSAI 2 is associated with to NSSRG 2 (or NSSRG value 2), the UE 3 determines that the S-NSSAI 1 and the S-NSSAI 2 do not belong to or do not share or are not associated with the common NSSRG (or the common NSSRG value), and may perform one of the options below.

See below for the options that the UE 3 takes:
The UE 3 does not initiate registration procedure (e.g. the UE 3 does not send a Registration Request message including the Requested NSSAI set with the S-NSSAI 2) as the S-NSSAI 1 and the S-NSSAI 2 do not belong to a common NSSRG value.
The UE 3 initiates registration procedure by sending a Registration Request message including the Requested NSSAI set with another S-NSSAI that belongs to a common NSSRG value with the S-NSSAI 1. For example, the UE 3 may initiate the registration procedure by sending the Registration Request message including the Requested NSSAI set with S-NSSAI 3 that is different from S-NSSAI 2 and belongs to (or shares) the common NSSRG value with the S-NSSAI 1. The UE 3 may select the another S-NSSAI from the Configured NSSAI based on the NSSRG information.
The UE 3 aborts the NSSAA procedure for the S-NSSAI 1 and the UE 3 initiates registration procedure by sending a Registration Request message including the Requested NSSAI set with the S-NSSAI 2 after completion of the aborting the NSSAA procedure for the S-NSSAI 1. For example, the UE 3 may initiate registration procedure by sending a Registration Request message including the Requested NSSAI set with the S-NSSAI 2 after completion of the aborting the NSSAA procedure for the S-NSSAI 1. For example, the UE 3 may delete the S-NSSAI 1 from the Pending NSSAI and set the S-NSSAI 1 to Rejected NSSAI after completion of the aborting the NSSAA procedure for the S-NSSAI 1.
The UE 3 waits to complete the NSSAA procedure for the S-NSSAI 1. After the completion of the NSSAA procedure for the S-NSSAI 1, the UE 3 initiates registration procedure by sending a Registration Request message including the Requested NSSAI set with the S-NSSAI 2. I.e., the S-NSSAI 1 is not included to the Requested NSSAI. It means that the UE 3 deletes the S-NSSAI 1 from the Allowed NSSAI in the UE 3. Alternatively, the UE 3 deletes the S-NSSAI 1 from the Allowed NSSAI in the UE 3 after completion of the NSSAA procedure for the S-NSSAI 1. For example, in a case where the UE 3 receives Allowed NSSAI including the S-NSSAI 1 after completion of the NSSAA procedure for the S-NSSAI 1, the UE 3 may discard the Allowed NSSAI or delete the S-NSSAI 1 from the Allowed NSSAI or set the S-NSSAI 1 to the Rejected NSSAI.
8) The registration procedure continues from the step 4 in section 4.2.2.2.2 of NPL 3.

In a case where the UE 3 initiates the registration procedure by sending the Registration Request message including the Requested NSSAI set with the S-NSSAI 2 in step 7, the registration procedure may continue from the step 4 in section 4.2.2.2.2 of NPL 3.

In a case where the UE 3 initiates the registration procedure by sending the Registration Request message including the Requested NSSAI set with the another S-NSSAI that belongs to a common NSSRG value with the S-NSSAI 1 in step 7, the registration procedure may continue from the step 4 in section 4.2.2.2.2 of NPL 3.

In a case where the UE 3 initiates the registration procedure by sending the Registration Request message including the Requested NSSAI set with the S-NSSAI 2 after completion of the aborting the NSSAA procedure for the S-NSSAI 1 in step 7, the registration procedure may continue from the step 4 in section 4.2.2.2.2 of NPL 3.

In a case where the UE 3 initiates the registration procedure by sending the Registration Request message including the Requested NSSAI set with the S-NSSAI 2 after completion of NSSAA procedure for the S-NSSAI 1 in step 7, the registration procedure may continue from the step 4 in section 4.2.2.2.2 of NPL 3.

For example, in a case where the S-NSSAI 1 and the S-NSSAI 2 are not associated with any common NSSRG value, the UE 3 may detect or determine that at least one of the Configured NSSAI and the NSSRG information in the UE 3 are not latest ones. In this case, the UE 3 may request at least one of latest Configured NSSAI and latest NSSRG information to the 5GC, and receive the at least one of latest Configured NSSAI and latest NSSRG information.

According to the First example of the First Aspect, for example, it can provide solution for ambiguous descriptions in 3GPP specification(s) how to handle the NSSRG.

According to the First example of the First Aspect, for example, it can provide a method of handling registration procedure in a case where S-NSSAI(s) of the Requested NSSAI in the Registration Request message does not belong to or does not share any common NSSRG value with S-NSSAI(s) in the Pending NSSAI.

According to the First example of the First Aspect, for example, it can provide a method of handling registration procedure in a case where S-NSSAI(s) of the Requested NSSAI in the Registration Request message belongs to or shares at least one common NSSRG value with S-NSSAI(s) in the Pending NSSAI.

### <Variant 1 of First Example of the First Aspect: >

In one example, in step 1, the UE 3 sends only S-NSSAI 1 in the Registration Request message. In this case the UE 3 and the AMF 70 have S-NSSAI 1 in Pending NSSAI. In step 6 the UE 3 receives trigger to register to S-NSSAI 2 and may perform processes in step 6. For example, the UE 3 may select S-NSSAI(s) from Configured NSSAI, and include the selected S-NSSAI(s) in the Requested NSSAI in the Registration Request message. For example, subset of the Configured NSSAI may be provided in the Requested NSSAI. For example, subset of the Configured NSSAI may be the Requested NSSAI. Variant 1 of First example of the First Aspect may be applied to Second example of the First Aspect below. For example, in a case where the UE 3 has the Pending NSSAI, the subset of Configured NSSAI provided in the Requested NSSAI and the Pending NSSAI may be associated with at least one common NSSRG value.

For example, in a case where the UE 3 initiates registration procedure (e.g. in step 6), the UE 3 may determine or check whether the UE 3 has Pending NSSAI. In a case where the UE 3 determines or checks that UE 3 has the Pending NSSAI and the UE 3 initiates registration procedure using the Requested NSSAI (e.g. the UE 3 initiates the registration procedure by sending a Registration Request message including the Requested NSSAI), the UE 3 may determine or check whether the subset of Configured NSSAI provided in the Requested NSSAI and the Pending NSSAI are associated with at least one common NSSRG value.

In a case where the UE 3 determines or checks that the subset of Configured NSSAI provided in the Requested NSSAI and the Pending NSSAI are associated with at least one common NSSRG value (e.g. in step 6), the UE 3 may perform the registration procedure using the Requested NSSAI (e.g. the UE 3 may send the Registration Request message including the Requested NSSAI. This process may be performed in step 7). The following processes (or subsequent processes) may be same as step 8 of FIG. 1.

### <Second Example of the First Aspect: >

A Second example of the First Aspect discloses a method where the AMF 70 checks whether the S-NSSAI(s) in the Pending NSSAI and the S-NSSAI(s) in the Requested NSSAI in the Registration Request message share at least one common NSSRG value or not. In a case where the S-NSSAI(s) in the Pending NSSAI and the S-NSSAI(s) in the Requested NSSAI don't share any common NSSRG value, then the AMF 70 provides Configured NSSAI and the NSSRG to a UE 3 to refresh configuration data in the UE 3.

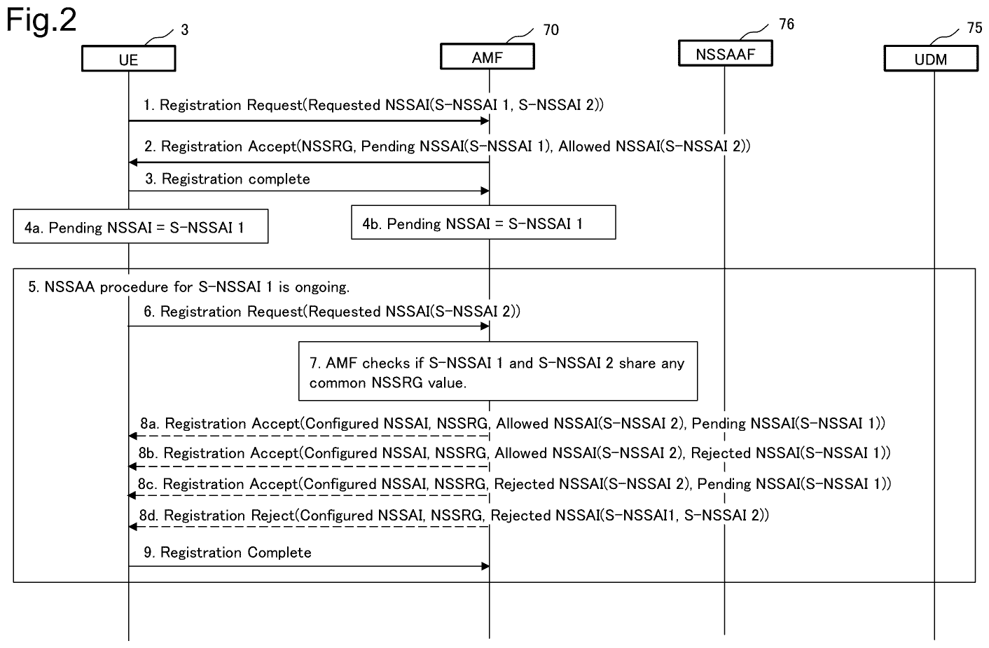

The detailed processes of the Second example of the First Aspect are described below, with reference to FIG. 2.
1) The UE 3 is configured to support the NSSRG procedure. The UE 3 initiates registration procedure to register S-NSSAI 1 and S-NSSAI 2 by sending the Registration Request message with Requested NSSAI which is set to the S-NSSAI 1 and the S-NSSAI 2. The Requested NSSAI may include one or more S-NSSAI(s). For example, the S-NSSAI 1 is subject to the NSSAA procedure.
2) When the AMF 70 receives the Registration Request message containing the S-NSSAI 1 and the S-NSSAI 2 in the Requested NSSAI, the AMF 70 identifies that the S-NSSAI 1 is subject to the NSSAA procedure. For example, the AMF 70 may identify that the S-NSSAI 1 is subject to the NSSAA procedure based on local configuration in the AMF 70 or operator's policy or information received from other network node. The AMF 70 marks the S-NSSAI 1 as the Pending NSSAI, the AMF 70 determines that the S-NSSAI 2 is allowed to use for the UE 3, and the AMF 70 sends Registration Accept message containing the S-NSSAI 1 in the Pending NSSAI and the S-NSSAI 2 in the Allowed NSSAI. The Registration Accept message may contain at least one of Configured NSSAI and NSSRG information as well. The NSSRG information may be information indicating NSSRG or information related to NSSRG. For example, the UE 3 can understand based on the NSSRG information which network slice (e.g. S-NSSAI) belongs to which NSSRG value or NSSRG. For example, the UE 3 can understand based on the NSSRG information which network slice(s) (e.g. S-NSSAI(s)) share to NSSRG value or NSSRG. For example, the UE 3 can understand based on the NSSRG information which network slice (e.g. S-NSSAI) is associated with which NSSRG value or NSSRG.

The AMF 70 may store the NSSRG information. For example, the AMF 70 can understand based on the NSSRG information which network slice (e.g. S-NSSAI) belongs to which NSSRG value or NSSRG. For example, the AMF 70 can understand based on the NSSRG information which network slice(s) (e.g. S-NSSAI(s)) share to NSSRG value or NSSRG. For example, the AMF 70 can understand based on the NSSRG information which network slice (e.g. S-NSSAI) is associated with which NSSRG value or NSSRG.

The AMF 70 may store the NSSRG information in advance or may receive the NSSRG information from other network node or may create the NSSRG information based on local configuration in the AMF 70 or operator's policy or information received from other network node.

The AMF 70 may know that the UE 3 has the Pending NSSAI including the S-NSSAI 1.
3) Upon receiving the Registration Accept message, the UE 3 stores the Pending NSSAI and the Allowed NSSAI. In a case where the Registration Accept message includes at least one of the Configured NSSAI and the NSSRG information, the UE 3 stores at least one of the Configured NSSAI and the NSSRG information. The UE 3 sends a Registration Complete message. For example, the UE 3 may send the Registration Complete message in a case where the UE 3 receives the Registration Accept message.
4a) At step 4a, the UE 3 has the S-NSSAI 1 in the Pending NSSAI. For example, the UE 3 may have the Pending NSSAI including the S-NSSAI 1. In addition, for example the UE 3 may have the Allowed NSSAI including the S-NSSAI 2.
4b) At step 4b, the AMF 70 stores the S-NSSAI 1 in the Pending NSSAI. For example, the AMF 70 may have the Pending NSSAI including the S-NSSAI 1.
5) The AMF 70 initiates the NSSAA procedure for the S-NSSAI 1 as defined in NPL 3.
6) The UE 3 gets a trigger to register the S-NSSAI 2. The UE 3 initiates registration procedure by sending a Registration Request message including the Requested NSSAI set to the S-NSSAI 2.

The UE 3 keeps the S-NSSAI 1 in the Pending NSSAI during the NSSAA procedure. The steps 6 to 9 may be performed during the NSSAA procedure for the S-NSSAI 1.
7) Upon reception of the Registration Request message from the UE 3, the AMF 70 checks whether the S-NSSAI 1 and the S-NSSAI 2 belong to at least one common NSSRG value (e.g. the AMF 70 checks whether the S-NSSAI 1 and the S-NSSAI 2 share at least one common NSSRG based on the NSSRG information or the AMF 70 checks whether the S-NSSAI 1 and the S-NSSAI 2 belong at least one common NSSRG value based on the NSSRG information, or the AMF 70 checks whether the S-NSSAI 1 and the S-NSSAI 2 belong at least one common NSSRG based on the NSSRG information or the AMF 70 check whether the S-NSSAI 1 and the S-NSSAI 2 are associated with at least one common NSSRG value based on the NSSRG information). The checking whether the S-NSSAI 1 and the S-NSSAI 2 belong to at least one common NSSRG value may be referred to as checking whether the S-NSSAI 1 and the S-NSSAI 2 are associated with at least one common NSSRG value.

Depending on an outcome of the checking in step 7, one of steps 8a, 8b, 8c and 8d takes place.
8a) If the S-NSSAI 1 and the S-NSSAI 2 share at least one common NSSRG value (e.g. if the S-NSSAI 1 and the S-NSSAI 2 share at least one common NSSRG or if the S-NSSAI 1 and the S-NSSAI 2 belong at least one common NSSRG value or if the S-NSSAI 1 and the S-NSSAI 2 belong at least one common NSSRG or if the S-NSSAI 1 and the S-NSSAI 2 are associated with at least one common NSSRG value) and the S-NSSAI 2 is allowed to use for the UE 3, the AMF 70 sends a Registration Accept message to the UE 3 including at least one of the NSSRG information, the S-NSSAI 2 set to the Allowed NSSAI and the S-NSSAI 1 set to the Pending NSSAI. The Registration Accept message may also include Configured NSSAI. For example, the AMF 70 may send the Registration Accept message to the UE 3 including the NSSRG information, the Allowed NSSAI which includes the S-NSSAI 2 and the Pending NSSAI which includes the S-NSSAI 1.

The UE 3 may store the Allowed NSSAI and the Pending NSSAI. For example, the UE 3 may use at least one of the received Configured NSSAI and the received NSSRG information to refresh or update data in the UE 3 (e.g. the Configured NSSAI and the NSSRG information which are previously stored in the UE 3).
8b) If the S-NSSAI 1 and the S-NSSAI 2 does not share at least one common NSSRG value (e.g. if the S-NSSAI 1 and the S-NSSAI 2 do not share a common NSSRG or if the S-NSSAI 1 and the S-NSSAI 2 do not belong a common NSSRG value or if the S-NSSAI 1 and the S-NSSAI 2 do not belong a common NSSRG or if the S-NSSAI 1 and the S-NSSAI 2 are not associated with any common NSSRG value) and the S-NSSAI 2 is allowed to use for the UE 3 and the AMF 70 decides that the S-NSSAI 2 is higher priority than the S-NSSAI 1 for the UE 3, the AMF 70 sends a Registration Accept message to the UE 3 including at least one of Configured NSSAI, NSSRG information, the S-NSSAI 2 set to the Allowed NSSAI and the S-NSSAI 1 set to the Rejected NSSAI. For example, the AMF 70 may send the Registration Accept message to the UE 3 including the Configured NSSAI, the NSSRG information, the Allowed NSSAI which includes the S-NSSAI 2 and the Rejected NSSAI which includes the S-NSSAI 1. For example, the AMF 70 may store information related to the priority of S-NSSAI(s) or may receive the information from other network nodes, and the AMF 70 may decide the priority of the S-NSSAI(s) based on the information. For example, the AMF 70 may decide the priority of S-NSSAI(s) based on local configuration of the AMF 70 or operator's policy.

Upon reception of the Registration Accept message from the AMF 70 including the S-NSSAI 1 in the Rejected NSSAI, as the S-NSSAI 1 is in the Pending NSSAI stored in the UE 3, the UE 3 removes the S-NSSAI 1 from the Pending NSSAI and stores the S-NSSAI 1 to the Rejected NSSAI. In addition, the UE 3 may initiate an abort process to ongoing NSSAA procedure for the S-NSSAI 1. The UE 3 may store the S-NSSAI 2 in the Allowed NSSAI. For example, the UE 3 may use at least one of the received Configured NSSAI and the received NSSRG information to refresh or update data in the UE 3 (e.g. the Configured NSSAI and the NSSRG information which are previously stored in the UE 3).

For example, the UE 3 may keep the ongoing NSSAA procedure for the S-NSSAI 1. In this case, if the UE 3 receives Allowed NSSAI including the S-NSSAI 1 after completion of the NSSAA procedure for the S-NSSAI 1, the UE 3 may not update Allowed NSSAI in the UE 3 based on the received Allowed NSSAI including the S-NSSAI 1. In this case, the UE 3 may discard the received Allowed NSSAI and keep the S-NSSAI 1 in the Rejected NSSAI.
8c) If the S-NSSAI 1 and the S-NSSAI 2 does not share at least one common NSSRG value (e.g. if the S-NSSAI 1 and the S-NSSAI 2 do not share a common NSSRG or if the S-NSSAI 1 and the S-NSSAI 2 do not belong a common NSSRG value or if the S-NSSAI 1 and the S-NSSAI 2 do not belong a common NSSRG or if the S-NSSAI 1 and the S-NSSAI 2 are not associated with any common NSSRG value) and the S-NSSAI 2 is allowed to use for the UE 3 and the AMF 70 decides that the S-NSSAI 1 is higher priority than the S-NSSAI 2 for the UE 3, the AMF 70 sends a Registration Accept message to the UE 3 including at least one of Configured NSSAI, NSSRG information, the S-NSSAI 2 set to the Reject NSSAI and the S-NSSAI 1 set to the Pending NSSAI. For example, the AMF 70 may send the Registration Accept message to the UE 3 including the Configured NSSAI, the NSSRG information, the Rejected NSSAI which includes the S-NSSAI 2 and the Pending NSSAI which includes the S-NSSAI 1.

Upon reception of the Registration Accept message from the AMF 70 including the S-NSSAI 2 in the Rejected NSSAI, as the S-NSSAI 2 is in the Allowed NSSAI stored in the UE 3, the UE 3 removes the S-NSSAI 2 from the Allowed NSSAI and stores the S-NSSAI 2 to the Rejected NSSAI. The UE 3 may store the S-NSSAI 1 in the Pending NSSAI. For example, the UE 3 may use at least one of the received Configured NSSAI and the received NSSRG information to refresh or update data in the UE 3 (e.g. the Configured NSSAI and the NSSRG information which are previously stored in the UE 3).
8d) If the S-NSSAI 1 and the S-NSSAI 2 does not share at least one common NSSRG value (e.g. if the S-NSSAI 1 and the S-NSSAI 2 do not share a common NSSRG or if the S-NSSAI 1 and the S-NSSAI 2 do not belong a common NSSRG value or if the S-NSSAI 1 and the S-NSSAI 2 do not belong a common NSSRG or if the S-NSSAI 1 and the S-NSSAI 2 are not associated with any common NSSRG value), the AMF 70 sends a Registration Reject message to the UE 3 including at least one of Configured NSSAI, NSSRG information, the S-NSSAI 1 and the S-NSSAI 2 set to the Rejected NSSAI. For example, the AMF 70 may send the Registration Reject message to the UE 3 including the Configured NSSAI, the NSSRG information, the Rejected NSSAI which includes the S-NSSAI 1 and the S-NSSAI 2.

Upon reception of the Registration Reject message from the AMF 70 including the S-NSSAI 1 and the S-NSSAI 2 in the Rejected NSSAI, as the S-NSSAI 1 is in the Pending NSSAI in the UE 3 and the S-NSSAI 2 is in the Allowed NSSAI in the UE 3, the UE 3 removes the S-NSSAI 1 from the Pending NSSAI, and removes the S-NSSAI 2 from the Allowed NSSAI, and stores the S-NSSAI 1 and S-NSSAI 2 to the Rejected NSSAI. In addition, the UE 3 initiates an abort process to ongoing NSSAA procedure for S-NSSAI 1. For example, the UE 3 may use at least one of the received Configured NSSAI and the received NSSRG information to refresh or update data in the UE 3 (e.g. the Configured NSSAI and the NSSRG information which are previously stored in the UE 3).

For example, the UE 3 may keep the ongoing NSSAA procedure for the S-NSSAI 1. In this case, if the UE 3 receives Allowed NSSAI including the S-NSSAI 1 after completion of the NSSAA procedure for the S-NSSAI 1, the UE 3 may not update Allowed NSSAI in the UE 3 based on the received Allowed NSSAI including the S-NSSAI 1. In this case, the UE 3 may discard the received Allowed NSSAI and keep the S-NSSAI 1 in the Rejected NSSAI.
9) If the Registration Accept message is sent from the AMF 70 to the UE 3 in step 8, the UE 3 may send a Registration Complete message to the AMF 70 to complete the registration procedure.

For example, in a case where the AMF 70 determines that the S-NSSAI 1 and the S-NSSAI 2 are not associated with any common NSSRG value, the AMF 70 may detect or determine that at least one of the Configured NSSAI and the NSSRG information in the UE 3 are not latest ones. In this case, the AMF 70 may send the Registration Accept message or the Registration Reject message as mentioned in step 8b, 8c or 8d.

The Configured NSSAI sent in step 8a, 8b 8c or 8d may be same to the Configured NSSAI sent in step 2.

The Configured NSSAI sent in step 8a, 8b 8c or 8d may be different the Configured NSSAI sent in step 2. In this case, the AMF 70 may create new Configured NSSAI or update the Configured NSSAI sent in step 2 based on local configuration in the AMF 70 or operator's policy or information received from other network node, and may send the new Configured NSSAI or the updated Configured NSSAI in step 8a, 8b 8c or 8d. The AMF 70 may request the new Configured NSSAI or the updated Configured NSSAI to other network node and may receive the new Configured NSSAI or the updated Configured NSSAI from the other network node. Then the AMF 70 may send the new Configured NSSAI or the updated Configured NSSAI in step 8a, 8b 8c or 8d.

The NSSRG information sent in step 8a, 8b 8c or 8d may be same to the NSSRG information sent in step 2.

The NSSRG information sent in step 8a, 8b 8c or 8d may be different the NSSRG information sent in step 2. In this case, the AMF 70 may create new NSSRG information or update the NSSRG information sent in step 2 based on local configuration in the AMF 70 or operator's policy or information received from other network node, and may send the new NSSRG information or the updated NSSRG information in step 8a, 8b 8c or 8d.

The AMF 70 may request the new NSSRG information or the updated NSSRG information to other network node and may receive the new NSSRG information or the updated NSSRG information from the other network node. Then the AMF 70 may send the new NSSRG information or the updated NSSRG information in step 8a, 8b 8c or 8d.

For example, in a case where the UE 3 has the Pending NSSAI and the S-NSSAI 2 of the Requested NSSAI in the Registration Request message and the Pending NSSAI (e.g. S-NSSAI 1 in the Pending NSSAI) are not associated with any common NSSRG value, the AMF 70 may send the new Configured NSSAI by using the Registration Reject message or the Registration Accept message (or the AMF 70 may include the new Configured NSSAI in the Registration Reject message or the Registration Accept message).

For example, in a case where the AMF 70 has the Pending NSSAI and the S-NSSAI 2 of the Requested NSSAI in the Registration Request message and the Pending NSSAI (e.g. S-NSSAI 1 in the Pending NSSAI) are not associated with any common NSSRG value, the AMF 70 may send the new Configured NSSAI by using the Registration Reject message or the Registration Accept message (or the AMF 70 may include the new Configured NSSAI in the Registration Reject message or the Registration Accept message).

According to the Second example of the First Aspect, for example, it can provide solution for ambiguous descriptions in 3GPP specification(s) how to handle the NSSRG.

According to the Second example of the First Aspect, for example, it can provide a method of handling registration procedure in a case where S-NSSAI(s) of the Requested NSSAI in the Registration Request message does not belong to or does not share any common NSSRG value with S-NSSAI(s) in the Pending NSSAI.

According to the Second example of the First Aspect, for example, it can provide a method of handling registration procedure in a case where S-NSSAI(s) of the Requested NSSAI in the Registration Request message belongs to or shares at least one common NSSRG value with S-NSSAI(s) in the Pending NSSAI.

For example, in a case where the S-NSSAI 1 and the S-NSSAI 2 does not share at least one common NSSRG value, there is possibility that at least one of the Configured NSSAI and the NSSRG information stored in the UE 3 are not latest ones. By checking whether the S-NSSAI 1 and the S-NSSAI 2 share at least one common NSSRG value, the AMF 70 can detect or determine whether at least one of the Configured NSSAI and the NSSRG information in the UE 3 may not be the latest ones (or may be old ones). In a case where the AMF 70 determines that the S-NSSAI 1 and the S-NSSAI 2 do not share at least one common NSSRG value (e.g. the AMF 70 detects or determines that at least one of the Configured NSSAI and the NSSRG information in the UE 3 may not be the latest ones), the AMF 70 sends at least one of the Configured NSSAI and the NSSRG information to refresh or update at least one of the Configured NSSAI and the NSSRG information stored in the UE 3. According to the Second example of the First Aspect, for example, the latest information (e.g. the Configured NSSAI and the NSSRG information) for performing the NSSRG feature is provide from the AMF 70 to the UE 3 in a case where the S-NSSAI 1 and the S-NSSAI 2 do not share at least one common NSSRG value and the NSSRG feature can work properly.

### <Variant 1 of Second Example of the First Aspect>

In steps 8b and 8d, the AMF 70 may initiate the AMF triggered Slice-Specific Authorization Revocation procedure. The AMF triggered Slice-Specific Authorization Revocation procedure may be one of outlined procedures below:
The AMF 70 sends a AAA protocol Revoke Auth request message to the NSSAAF 76 including the S-NSSAI 1 and GPSI for UE 3 requesting revocation of authorization for the S-NSSAI 1.
The AMF 70 sends a message to an AAA server for the S-NSSAI 1 including S-NSSAI 1 and GPSI for UE 3 requesting revocation of authorization for the S-NSSAI 1.

### <Variant 2 of Second Example of the First Aspect>

For example, the AMF 70 may know that contents of Configured NSSAI for the UE 3 or that the UE 3 has the Configured NSSAI. For example, in a case where the AMF 70 receives, from the UE 3, a Registration Request message including Requested NSSAI (e.g. in step 6), the AMF 70 may determine or check whether subset of Configured NSSAI provided in the Requested NSSAI and Pending NSSAI (e.g. Pending NSSAI for UE 3) are associated with at least one common NSSRG value (e.g. in step 7). Depending on the determination or the checking, the AMF 70 may perform one of steps 8a to 8d. For example, in a case where the AMF 70 determines that the subset of Configured NSSAI provided in the Requested NSSAI and the Pending NSSAI are associated with at least one common NSSRG value, the AMF 70 may perform the process in step 8a (e.g. the AMF 70 may send the Registration Accept message in step 8a). For example, in a case where the AMF 70 determines that the subset of Configured NSSAI provided in the Requested NSSAI and the Pending NSSAI are not associated with at least one common NSSRG value, the AMF 70 may perform the process in one of steps 8b to 8d (e.g. the AMF 70 may send the Registration Accept message in step 8b or the AMF 70 may send the Registration Accept message in step 8c or the AMF 70 may send the Registration Reject message in step 8d).

### <Second Aspect>

The NSSRG (Network Slice Simultaneous Registration Group) is introduced to the 5GS in release 17. The NSSRG feature provides 3GPP operator(s) mechanism for limiting a combination of network slices to be registered to the end user at the same time. According to current 3GPP specification(s), the NSSRG information (e.g. information indicating NSSRG or information related to NSSRG) is provided to a UE from 5GC, and the UE chooses the network slice(s) based on the NSSRG information. However, it is not clear in 3GPP specification(s) what the 5GC is supposed to do if the UE holds an old Configured network slice(s) (e.g. old Configured NSSAI) and/or old NSSRG information. In this case, the NSSRG feature does not work properly.

For example, this aspect focuses on an issue when an AMF 70 detects, based on the NSSRG information, that S-NSSAI(s) in Requested NSSAI in a Registration Request message from a UE 3 includes S-NSSAI(s) that is not compatible with S-NSSAI(s) in the Allowed NSSAI for another access type in the AMF 70. For example, this aspect provides solution for this issue.

For example, as the S-NSSAI(s) in the Requested NSSAI and the S-NSSAI(s) in the Allowed NSSAI for another access type cannot be allowed to be registered at the same time, the AMF 70 detects that at least one of Configured NSSAI and NSSRG information in the UE 3 are not the latest ones. For example, the AMF 70 detects that at least one of the Configured NSSAI and the NSSRG information in the UE 3 are out of date. In this case, the AMF 70 provides Configured NSSAI information and NSSRG information to the UE 3 to refresh data in the UE 3.

For example, this aspect also discloses a method of handling registration procedure in a case where S-NSSAI(s) of the Requested NSSAI in the Registration Request message does not belong to or does not share any common NSSRG value with S-NSSAI(s) in Allowed NSSAI for another access type.

### <First Example of the Second Aspect: >

A First example of the Second Aspect discloses a method where the AMF 70 checks whether S-NSSAI(s) in Allowed NSSAI over one access type and the Requested NSSAI(s) in the Registration Request message over another access type share at least one common NSSRG value. In a case where the S-NSSAI(s) in the Allowed NSSAI over one access and S-NSSAI(s) in the Requested NSSAI(s) over another access don't share a common NSSRG value then the AMF 70 sends a Registration Accept message to the UE 3 containing Configured NSSAI and NSSRG information to refresh configuration data in the UE 3.

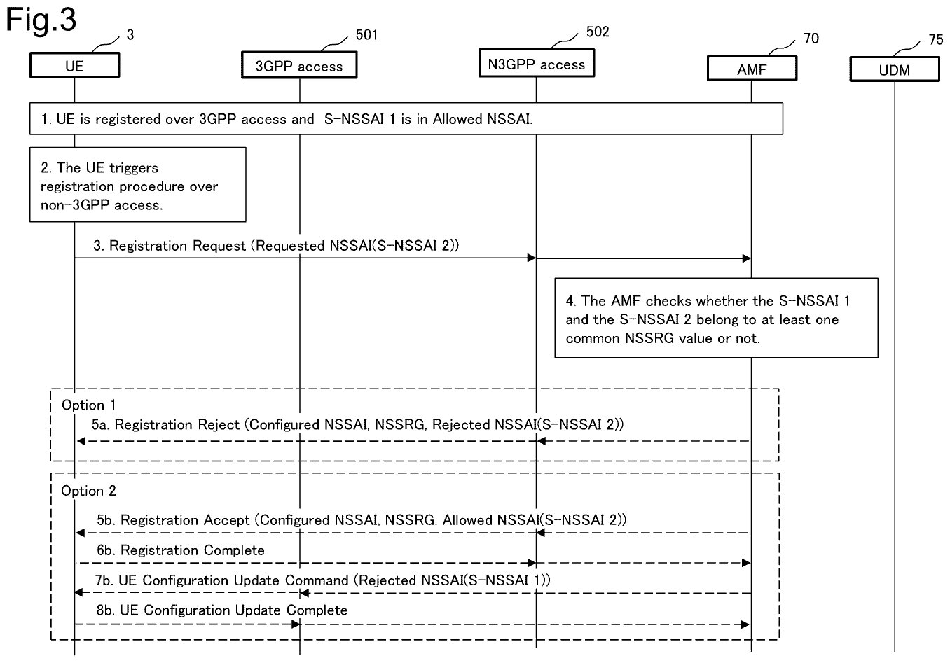

The detailed processes of the First example of the Second Aspect are described below, with reference to FIG. 3.
1) The UE 3 is registered over one access (e.g. 3GPP access 501) and S-NSSAI 1 is in Allowed NSSAI in the UE 3. For example, the UE 3 has the Allowed NSSAI including the S-NSSAI 1 for the 3GPP access. For example, the AMF 70 has the Allowed NSSAI including the S-NSSAI 1 for the 3GPP access. The UE 3 is configured to perform registration procedure over one access (e.g. the 3GPP access) and another access (e.g. non-3GPP access 502). For example, the UE 3 and the AMF 70 may perform a registration procedure using the S-NSSAI 1 over the 3GPP access, and the UE 3 and the AMF 70 may have the Allowed NSSAI including the S-NSSAI 1. The AMF 70 may know that the UE 3 has the Allowed NSSAI including the S-NSSAI 1.
2) The UE 3 gets a trigger to registration procedure for S-NSSAI 2 over another access (e.g. non-3GPP access 502 or N3GPP access 502).
3) The UE 3 sends a Registration Request message including the S-NSSAI 2 in the Requested NSSAI over the non-3GPP access.
4) Upon receiving the Registration Request message, the AMF 70 checks whether the S-NSSAI 1 which is in the Allowed NSSAI over the 3GPP access and the S-NSSAI 2 in the Requested NSSAI in the Registration Request message belong to at least one common NSSRG value or not (e.g. the AMF 70 checks whether the S-NSSAI 1 and the S-NSSAI 2 share at least one common NSSRG based on NSSRG information or the AMF 70 checks whether the S-NSSAI 1 and the S-NSSAI 2 share at least one common NSSRG value based on the NSSRG information, or the UE 3 checks whether the S-NSSAI 1 and the S-NSSAI 2 belong at least one common NSSRG based on the NSSRG information or the AMF 70 check whether the S-NSSAI 1 and the S-NSSAI 2 are associated with at least one common NSSRG value based on the NSSRG information).

The AMF 70 may store the NSSRG information in advance or may receive the NSSRG information from other network node or may create the NSSRG information based on local configuration in the AMF 70 or operator's policy or information received from other network node.

For example, the AMF 70 can understand based on the NSSRG information which network slice (e.g. S-NSSAI) belongs to which NSSRG value or NSSRG. For example, the AMF 70 can understand based on the NSSRG information which network slice(s) (e.g. S-NSSAI(s)) share to NSSRG value or NSSRG. For example, the AMF 70 can understand based on the NSSRG information which network slice (e.g. S-NSSAI) is associated with which NSSRG value or NSSRG.

Depending on an outcome of the checking, there are two options to take.

### Option 1:

This is an option that the AMF 70 rejects the Registration Request message due to no common NSSRG value between S-NSSAI 1 in the Requested NSSAI and S-NSSAI 2 in the Allowed NSSAI over 3GPP access.
5a) The AMF 70 sends a Registration Reject message to the UE 3 including at least one of Configured NSSAI, NSSRG information and the S-NSSAI 2 set to the Rejected NSSAI. For example, in a case where the AMF 70 determines that the S-NSSAI 1 and the S-NSSAI 2 do not belong to or share the common NSSRG or the common NSSRG value (or in a case where the AMF 70 determines that the S-NSSAI 1 and the S-NSSAI 2 are not associated with any common NSSRG or any common NSSRG value), the AMF 70 may send the Registration Reject message including the Configured NSSAI, the NSSRG information and the Rejected NSSAI which includes the S-NSSAI 2.

Upon reception of the Registration Reject message, the UE 3 stores at least one of the Configured NSSAI, the NSSRG information and the S-NSSAI 2 set to the Rejected NSSAI. For example, the UE 3 may use at least one of the received Configured NSSAI and the received NSSRG information to refresh or update data in the UE 3 (e.g. the Configured NSSAI and the NSSRG information which are previously stored in the UE 3).

### Option 2:

This is an option that the AMF 70 accepts the Registration Request with the S-NSSAI 2. As S-NSSAI 2 is accepted, the AMF 70 updates the S-NSSAI 1 over the non-3GPP access to be rejected as there is no common NSSRG value between the S-NSSAI 1 and the S-NSSAI 2.
5b) The AMF 70 sends a Registration Accept message to the UE 3 including Configured NSSAI, NSSRG information and the S-NSSAI 2 set to the Allowed NSSAI. For example, in a case where the AMF 70 determines that the S-NSSAI 1 and the S-NSSAI 2 do not belong to or share the common NSSRG or the common NSSRG value (or in a case where the AMF 70 determines that the S-NSSAI 1 and the S-NSSAI 2 are not associated with any common NSSRG or any common NSSRG value), the AMF 70 may send the Registration Accept message including the Configured NSSAI, the NSSRG information and the Allowed NSSAI which includes the S-NSSAI 2. For example, the AMF 70 may send the Registration Accept message over the non-3GPP access.

Upon reception of the Registration Accept message, the UE 3 stores at least one of the Configured NSSAI, the NSSRG information and the S-NSSAI 2 set to the Allowed NSSAI. For example, the UE 3 may use at least one of the received Configured NSSAI and the received NSSRG information to refresh or update data in the UE 3 (e.g. the Configured NSSAI and the NSSRG information which are previously stored in the UE 3).
6b) The UE 3 sends a Registration Complete message to the AMF 70. For example, in a case where the UE 3 receives the Registration Accept message from the AMF 70, the UE 3 may send the Registration Complete message to the AMF 70. For example, the UE 3 may send the Registration Complete message over the non-3GPP access.
7b) The AMF 70 sends a UE Configuration Update Command message to the UE 3 over the 3GPP access including at least one of Configured NSSAI, NSSRG information and the S-NSSAI 1 set to the Rejected NSSAI. For example, the AMF 70 may send the UE Configuration Update Command message including the Configured NSSAI, the NSSRG information and the Rejected NSSAI which includes the S-NSSAI 1. For example, the AMF 70 may send the UE Configuration Update Command message after receiving the Registration Complete message in step 6b. For example, the AMF 70 may send the UE Configuration Update Command message after sending the Registration Accept message in step 5b.

Upon reception of the UE Configuration Update Command message, the UE 3 stores at least one of the Configured NSSAI, the NSSRG information and the S-NSSAI 1 set to the Rejected NSSAI for the 3GPP access.

For example, the UE 3 may delete the S-NSSAI 1 from the Allowed NSSAI for the 3GPP access, and store the Rejected NSSAI including the S-NSSAI 1 for the 3GPP access.

For example, the UE 3 may use at least one of the received Configured NSSAI and the received NSSRG information to refresh or update data in the UE 3 (e.g. the Configured NSSAI and the NSSRG information which are previously stored in the UE 3).
8b) The UE 3 sends a UE Configuration Update Complete message to the AMF 70 over the 3GPP access. For example, in a case where the UE 3 receives the UE Configuration Update Command message from the AMF 70, the UE 3 may send the UE Configuration Update Complete message to the AMF 70.

The AMF 70 may create new Configured NSSAI or update the Configured NSSAI sent to the UE 3 previously based on local configuration in the AMF 70 or operator's policy or information received from other network node, and may send the new Configured NSSAI or the updated Configured NSSAI in step 5a, 5b or 7b.

The AMF 70 may request the new Configured NSSAI or the updated Configured NSSAI to other network node and may receive the new Configured NSSAI or the updated Configured NSSAI from the other network node. Then the AMF 70 may send the new Configured NSSAI or the updated Configured NSSAI in step 5a, 5b or 7b.

For example, the Configured NSSAI in step 5a or step 5b may be configured for the non-3GPP access. For example, the Configured NSSAI in step 5b and step 7b may be configured so as to be common to the 3GPP access and the non-3GPP access. For example, the Configured NSSAI in step 5a and step 7b may be configured so as to be different between the 3GPP access and the non-3GPP access. For example, the Configured NSSAI in steps 5a and 5b may be for the non-3GPP access, and the Configured NSSAI in steps 7b may be for the 3GPP access.

The AMF 70 may create new NSSRG information or update the NSSRG information sent to the UE 3 previously based on local configuration in the AMF 70 or operator's policy or information received from other network node, and may send the new NSSRG information or the updated NSSRG information in step 5a, 5b or 7b.

The AMF 70 may request the new NSSRG information or the updated NSSRG information to other network node and may receive the new NSSRG information or the updated NSSRG information from the other network node. Then the AMF 70 may send the new NSSRG information or the updated NSSRG information in step 5a, 5b or 7b.

For example, the NSSRG information in step 5a or step 5b may be configured for the non-3GPP access. For example, the NSSRG information in step 5b and step 7b may be configured so as to be common to the 3GPP access and the non-3GPP access. For example, the NSSRG information in step 5a and step 7b may be configured so as to be different between the 3GPP access and the non-3GPP access. For example, the NSSRG information in steps 5a and 5b may be for the non-3GPP access, and the NSSRG information in steps 7b may be for the 3GPP access

For example, in a case where the AMF 70 determines that the S-NSSAI 1 and the S-NSSAI 2 belong to common NSSRG value in step 4, the AMF 70 may send, to the UE 3, a Registration Accept message including Allowed NSSAI for the non-3GPP access which includes the S-NSSAI 2.

For example, in a case where the UE 3 has already the Allowed NSSAI for the 3GPP access and the S-NSSAI 2 of the Requested NSSAI in the Registration Request message and the Allowed NSSAI (e.g. S-NSSAI 1 in the Allowed NSSAI) are not associated with any common NSSRG value, the AMF 70 may send the new Configured NSSAI by using the Registration Reject message or the Registration Accept message (or the AMF 70 may include the new Configured NSSAI in the Registration Reject message or the Registration Accept message).

For example, in a case where the AMF 70 has already the Allowed NSSAI for the 3GPP access and the S-NSSAI 2 of the Requested NSSAI in the Registration Request message and the Allowed NSSAI (e.g. S-NSSAI 1 in the Allowed NSSAI) are not associated with any common NSSRG value, the AMF 70 may send the new Configured NSSAI by using the Registration Reject message or the Registration Accept message (or the AMF 70 may include the new Configured NSSAI in the Registration Reject message or the Registration Accept message).

For example, in a case where the AMF 70 has already the Allowed NSSAI for the 3GPP access and the S-NSSAI 2 of the Requested NSSAI in the Registration Request message over the non-3GPP access and the Allowed NSSAI (e.g. S-NSSAI 1 in the Allowed NSSAI) for the 3GPP access are not associated with any common NSSRG value, the AMF 70 may send the new Configured NSSAI by using the Registration Reject message or the Registration Accept message (or the AMF 70 may include the new Configured NSSAI in the Registration Reject message or the Registration Accept message).

For example, in a case where the UE 3 (or the AMF 70) has already the Allowed NSSAI for the other access and the S-NSSAI 2 of the Requested NSSAI in the Registration Request message over the current access and the Allowed NSSAI (e.g. S-NSSAI 1 in the Allowed NSSAI) for the other access are not associated with any common NSSRG value, the AMF 70 may send the new Configured NSSAI by using the Registration Reject message or the Registration Accept message (or the AMF 70 may include the new Configured NSSAI in the Registration Reject message or the Registration Accept message).

The Registration Accept message in step 5b may include information indicating that the UE Configuration Update Command message will be sent. In a case where the UE 3 receives the information, the UE 3 may not send, over the 3GPP access, a Registration Request message including Requested NSSAI which includes the S-NSSAI 1 or other NAS message related to the S-NSSAI 1 until the UE 3 receives the UE Configuration Update Command message.

According to the First example of the Second Aspect, for example, it can provide solution for ambiguous descriptions in 3GPP specification(s) how to handle the NSSRG.

According to the First example of the Second Aspect, for example, it can provide a method of handling registration procedure in a case where S-NSSAI(s) of the Requested NSSAI in the Registration Request message over one access does not belong to or does not share any common NSSRG value with S-NSSAI(s) in the Allowed NSSAI for another access.

According to the First example of the Second Aspect, for example, it can provide a method of handling registration procedure in a case where S-NSSAI(s) of the Requested NSSAI in the Registration Request message over one access belongs to or shares at least one common NSSRG value with S-NSSAI(s) in the Allowed NSSAI for another access.

For example, in a case where the S-NSSAI 1 and the S-NSSAI 2 does not share at least one common NSSRG value, there is possibility that at least one of the Configured NSSAI and the NSSRG information stored in the UE 3 are not latest ones. By checking whether the S-NSSAI 1 and the S-NSSAI 2 share at least one common NSSRG value, the AMF 70 can detect or determine whether at least one of the Configured NSSAI and the NSSRG information in the UE 3 may not be the latest ones (or may be old ones). In a case where the AMF 70 determines that the S-NSSAI 1 and the S-NSSAI 2 does not share at least one common NSSRG value (e.g. the AMF 70 detects or determines that at least one of the Configured NSSAI and the NSSRG information in the UE 3 may not be the latest ones), the AMF 70 sends at least one of the Configured NSSAI and the NSSRG information to refresh or update at least one of the Configured NSSAI and the NSSRG information stored in the UE 3. According to the First example of the Second Aspect, for example, the latest information (e.g. the Configured NSSAI and the NSSRG information) for performing the NSSRG feature is provide from the AMF 70 to the UE 3 in a case where the S-NSSAI 1 and the S-NSSAI 2 does not share at least one common NSSRG value and the NSSRG feature can work properly.

### <Variant 1 of First Example of the Second Aspect>

Although this example explains a situation where the UE 3 sends the Registration Request message to the AMF 70 over the non-3GPP access while the UE 3 has the Allowed NSSAI over the 3GPP access, the First example of the Second Aspect is equally effective to a situation where the UE 3 sends the Registration Request message to the AMF 70 over 3GPP access while the UE 3 has the Allowed NSSAI over the non-3GPP access.

### <Variant 2 of First Example of the Second Aspect>

The steps 7b and 8b can takes place before steps 5b and 6b. Step 7b may be performed after step 5b. Step 5b may be performed after step 7b.

### <System Overview>

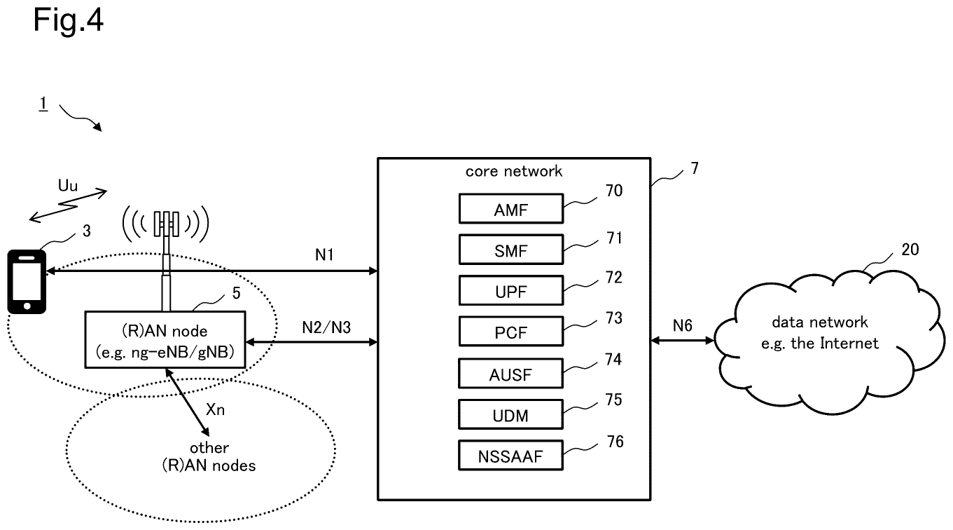

FIG. 4 schematically illustrates a telecommunication system 1 for a mobile (cellular or wireless) to which the above aspects are applicable.

The telecommunication system 1 represents a system overview in which an end to end communication is possible. For example, UE 3 (or user equipment, ‘mobile device’ 3) communicates with other UEs 3 or service servers in the data network 20 via respective (R)AN nodes 5 and a core network 7.

The (R)AN node 5 supports any radio accesses including a 5G radio access technology (RAT), an E-UTRA radio access technology, a beyond 5G RAT, a 6G RAT and non-3GPP RAT including wireless local area network (WLAN) technology as defined by the Institute of Electrical and Electronics Engineers (IEEE).

The (R)AN node 5 may split into a Radio Unit (RU), Distributed Unit (DU) and Centralized Unit (CU). In some aspects, each of the units may be connected to each other and structure the (R)AN node 5 by adopting an architecture as defined by the Open RAN (O-RAN) Alliance, where the units above are referred to as O-RU, O-DU and O-CU respectively.

The (R)AN node 5 may be split into control plane function and user plane function. Further, multiple user plane functions can be allocated to support a communication. In some aspects, user traffic may be distributed to multiple user plane functions and user traffic over each user plane functions are aggregated in both the UE 3 and the (R)AN node 5. This split architecture may be called as ‘dual connectivity’ or ‘Multi connectivity’.

The (R)AN node 5 can also support a communication using the satellite access. In some aspects, the (R)AN node 5 may support a satellite access and a terrestrial access.

In addition, the (R)AN node 5 can also be referred as an access node for a non-wireless access. The non-wireless access includes a fixed line access as defined by the Broadband Forum (BBF) and an optical access as defined by the Innovative Optical and Wireless Network (IOWN).

The core network 7 may include logical nodes (or ‘functions’) for supporting a communication in the telecommunication system 1. For example, the core network 7 may be 5G Core Network (5GC) that includes, amongst other functions, control plane functions and user plane functions. Each function in logical nodes can be considered as a network function. The network function may be provided to another node by adapting the Service Based Architecture (SBA).

A Network Function can be deployed as distributed, redundant, stateless, and scalable that provides the services from several locations and several execution instances in each location by adapting the network virtualization technology as defined by the European Telecommunications Standards Institute, Network Functions Virtualization (ETSI NFV).

The core network 7 may support the Non-Public Network (NPN). The NPN may be a Stand-alone Non-Public Network (SNPN) or a Public Network Integrated NPN (PN1-NPN).

As is well known, a UE 3 may enter and leave the areas (i.e. radio cells) served by the (R)AN node 5 as the UE 3 is moving around in the geographical area covered by the telecommunication system 1. In order to keep track of the UE 3 and to facilitate movement between the different (R)AN nodes 5, the core network 7 comprises at least one access and mobility management function (AMF) 70. The AMF 70 is in communication with the (R)AN node 5 coupled to the core network 7. In some core networks, a mobility management entity (MME) or a mobility management node for beyond 5G or a mobility management node for 6G may be used instead of the AMF 70.

The core network 7 also includes, amongst others, a Session Management Function (SMF) 71, a User Plane Function (UPF) 72, a Policy Control Function (PCF) 73, an Authentication Server Function (AUSF) 74, a Unified Data Management (UDM) 75, and a Network Slice-Specific Authentication and Authorization Function (NSSAAF) 76. When the UE 3 is roaming to a visited Public Land Mobile Network (VPLMN), a home Public Land Mobile Network (HPLMN) of the UE 3 provides the UDM 75 and at least some of the functionalities of the SMF 71, UPF 72, and PCF 73 for the roaming-out UE 3.

The UE 3 and a respective serving (R)AN node 5 are connected via an appropriate air interface (for example the so-called “Uu” interface and/or the like). Neighboring (R)AN node 5 are connected to each other via an appropriate (R)AN node 5 to (R)AN node interface (such as the so-called “Xn” interface and/or the like). Each (R)AN node 5 is also connected to nodes in the core network 7 (such as the so-called core network nodes) via an appropriate interface (such as the so-called “N2”/“N3” interface(s) and/or the like). From the core network 7, connection to a data network 20 is also provided. The data network 20 can be an internet, a public network, an external network, a private network or an internal network of the PLMN. In case that the data network 20 is provided by a PLMN operator or Mobile Virtual Network Operator (MVNO), the IP Multimedia Subsystem (IMS) service may be provided by that data network 20. The UE 3 can be connected to the data network 20 using IPv4, IPV6, IPv4v6, Ethernet or unstructured data type.

The “Uu” interface may include a Control plane of Uu interface and User plane of Uu interface.

The User plane of Uu interface is responsible to convey user traffic between the UE 3 and a serving (R)AN node 5. The User plane of Uu interface may have a layered structure with SDAP, PDCP, RLC and MAC sublayer over the physical connection.

The Control plane of Uu interface is responsible to establish, modify and release a connection between the UE 3 and a serving (R)AN node 5. The Control plane of Uu interface may have a layered structure with RRC, PDCP, RLC and MAC sublayers over the physical connection.

For example, the following messages are communicated over the RRC layer to support AS signaling.
RRC Setup Request message: This message is sent from the UE 3 to the (R)AN node 5. In addition to the parameters that are disclosed by Aspects in this disclosure, following parameters may be included together in the RRC Setup Request message.
establishmentCause and ue-Identity. The ue-Identity may have a value of ng-5G-S-TMSI-Part1 or randomValue.
RRC Setup message: This message is sent from the (R)AN node 5 to the UE 3. In addition to the parameters that are disclosed by Aspects in this disclosure, following parameters may be included together in the RRC Setup message.
masterCellGroup and radioBearerConfig
RRC setup complete message: This message is sent from the UE 3 to the (R)AN node 5. In addition to the parameters that are disclosed by Aspects in this disclosure, following parameters may be included together in the RRC setup complete message.
guami-Type, iab-NodeIndication, idleMeasAvailable, mobility State, ng-5G-S-TMSI-Part2, registeredAMF, selectedPLMN-Identity

The UE 3 and the AMF 70 are connected via an appropriate interface (for example the so-called N1 interface and/or the like). The N1 interface is responsible to provide a communication between the UE 3 and the AMF 70 to support NAS signaling. The N1 interface may be established over a 3GPP access and over a non-3GPP access. For example, the following messages are communicated over the N1 interface.
registration request message: This message is sent from the UE 3 to the AMF 70. In addition to the parameters that are disclosed by Aspects in this disclosure, following parameters may be included together in the registration request message.
5GS registration type, ngKSI, 5GS mobile identity, Non-current native NAS key set identifier, 5GMM capability, UE security capability, Requested NSSAI, Last visited registered TAI, S1 UE network capability, Uplink data status, PDU session status, MICO indication, UE status, Additional GUTI, Allowed PDU session status, UE's usage setting, Requested DRX parameters, EPS NAS message container, LADN indication, Payload container type, Payload container, Network slicing indication, 5GS update type, Mobile station classmark 2, Supported codecs, NAS message container, EPS bearer context status, Requested extended DRX parameters, T3324 value, UE radio capability ID, Requested mapped NSSAI, Additional information requested, Requested WUS assistance information, N5GC indication and Requested NB-N1 mode DRX parameters.
registration accept message: This message is sent from the AMF 70 to the UE 3. In addition to the parameters that are disclosed by Aspects in this disclosure, following parameters may be included together in the registration accept message.
5GS registration result, 5G-GUTI, Equivalent PLMNs, TAI list, Allowed NSSAI, Rejected NSSAI, Configured NSSAI, 5GS network feature support, PDU session status, PDU session reactivation result, PDU session reactivation result error cause, LADN information, MICO indication, Network slicing indication, Service area list, T3512 value, Non-3GPP de-registration timer value, T3502 value, Emergency number list, Extended emergency number list, SOR transparent container, EAP message, NSSAI inclusion mode, Operator-defined access category definitions, Negotiated DRX parameters, Non-3GPP NW policies, EPS bearer context status, Negotiated extended DRX parameters, T3447 value, T3448 value, T3324 value, UE radio capability ID, UE radio capability ID deletion indication, Pending NSSAI, Ciphering key data, CAG information list, Truncated 5G-S-TMSI configuration, Negotiated WUS assistance information, Negotiated NB-N1 mode DRX parameters and Extended rejected NSSAI.
Registration Complete message: This message is sent from the UE 3 to the AMF 70. In addition to the parameters that are disclosed by Aspects in this disclosure, following parameters may be included together in the Registration Complete message.
SOR transparent container.
Authentication Request message: This message is sent from the AMF 70 to the UE 3. In addition to the parameters that are disclosed by Aspects in this disclosure, following parameters may be included together in the Authentication Request message.
ngKSI, ABBA, Authentication parameter RAND (5G authentication challenge), Authentication parameter AUTN (5G authentication challenge) and EAP message.
Authentication Response message: This message is sent from the UE 3 to the AMF 70. In addition to the parameters that are disclosed by Aspects in this disclosure, following parameters may be populated together in the Authentication Response message. Authentication response message identity, Authentication response parameter and EAP message.
Authentication Result message: This message is sent from the AMF 70 to the UE 3. In addition to the parameters that are disclosed by Aspects in this disclosure, following parameters may be populated together in the Authentication Result message.
ngKSI, EAP message and ABBA.
Authentication Failure message: This message is sent from the UE 3 to the AMF 70. In addition to the parameters that are disclosed by Aspects in this disclosure, following parameters may be populated together in the Authentication Failure message.
Authentication failure message identity, 5GMM cause and Authentication failure parameter.
Authentication Reject message: This message is sent from the AMF 70 to the UE 3. In addition to the parameters that are disclosed by Aspects in this disclosure, following parameters may be populated together in the Authentication Reject message.
EAP message.
Service Request message: This message is sent from the UE 3 to the AMF 70. In addition to the parameters that are disclosed by Aspects in this disclosure, following parameters may be populated together in the Service Request message.
ngKSI, Service type, 5G-S-TMSI, Uplink data status, PDU session status, Allowed PDU session status, NAS message container.
Service Accept message: This message is sent from the AMF 70 to the UE 3. In addition to the parameters that are disclosed by Aspects in this disclosure, following parameters may be populated together in the Service Accept message.
PDU session status, PDU session reactivation result, PDU session reactivation result error cause, EAP message and T3448 value.
Service Reject message: This message is sent from the AMF 70 to the UE 3. In addition to the parameters that are disclosed by Aspects in this disclosure, following parameters may be populated together in the Service Reject message.
5GMM cause, PDU session status, T3346 value, EAP message, T3448 value and CAG information list.
Configuration Update Command message: This message is sent from the AMF 70 to the UE 3. In addition to the parameters that are disclosed by Aspects in this disclosure, following parameters may be populated together in the Configuration Update Command message.
Configuration update indication, 5G-GUTI, TAI list, Allowed NSSAI, Service area list, Full name for network, Short name for network, Local time zone, Universal time and local time zone, Network daylight saving time, LADN information, MICO indication, Network slicing indication, Configured NSSAI, Rejected NSSAI, Operator-defined access category definitions, SMS indication, T3447 value, CAG information list, UE radio capability ID, UE radio capability ID deletion indication, 5GS registration result, Truncated 5G-S-TMSI configuration, Additional configuration indication and Extended rejected NSSAI.
Configuration Update Complete message: This message is sent from the UE 3 to the AMF 70. In addition to the parameters that are disclosed by Aspects in this disclosure, following parameters may be populated together in the Configuration Update Complete message.
Configuration update complete message identity.

### <User Equipment (UE)>

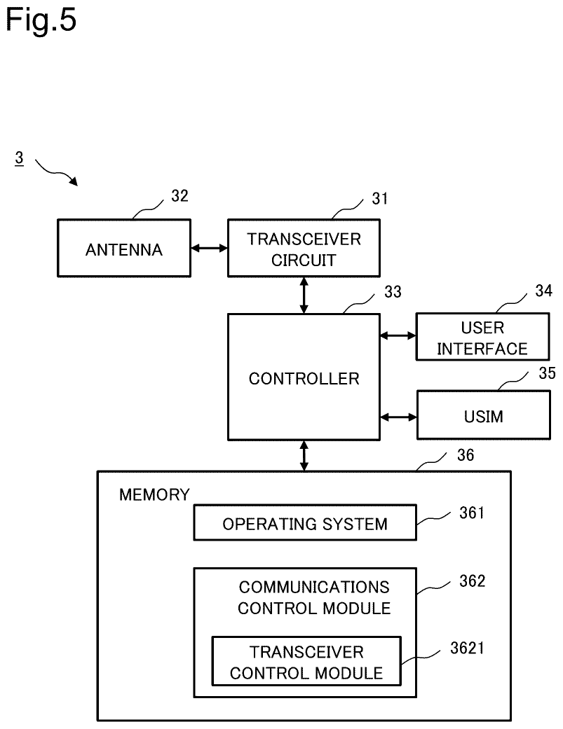

FIG. 5 is a block diagram illustrating the main components of the UE 3 (mobile device 3). As shown, the UE 3 includes a transceiver circuit 31 which is operable to transmit signals to and to receive signals from the connected node(s) via one or more antennas 32. Further, the UE 3 may include a user interface 34 for inputting information from outside or outputting information to outside. Although not necessarily shown in the Figure, the UE 3 may have all the usual functionality of a conventional mobile device and this may be provided by any one or any combination of hardware, software and firmware, as appropriate. Software may be pre-installed in the memory and/or may be downloaded via the telecommunication network or from a removable data storage device (RMD), for example. A controller 33 controls the operation of the UE 3 in accordance with software stored in a memory 36. The software includes, among other things, an operating system 361 and a communications control module 362 having at least a transceiver control module 3621. The communications control module 362 (using its transceiver control module 3621) is responsible for handling (generating/sending/receiving) signalling and uplink/downlink data packets between the UE 3 and other nodes, such as the (R)AN node 5 and the AMF 70. Such signalling may include, for example, appropriately formatted signalling messages (e.g. a registration request message and associated response messages) relating to access and mobility management procedures (for the UE 3). The controller 33 interworks with one or more Universal Subscriber Identity Module (USIM) 35. If there are multiple USIMs 35 equipped, the controller 33 may activate only one USIM 35 or may activate multiple USIMs 35 at the same time.

The UE 3 may, for example, support the Non-Public Network (NPN), The NPN may be a Stand-alone Non-Public Network (SNPN) or a Public Network Integrated NPN (PN1-NPN).

The UE 3 may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

The UE 3 may, for example, be an item of transport equipment (for example transport equipment such as: rolling stocks; motor vehicles; motor cycles; bicycles; trains; buses; carts; rickshaws; ships and other watercraft; aircraft; rockets; satellites; drones; balloons etc.).

The UE 3 may, for example, be an item of information and communication equipment (for example information and communication equipment such as: electronic computer and related equipment; communication and related equipment; electronic components etc.).

The UE 3 may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

The UE 3 may, for example, be an electrical application system or equipment (for example an electrical application system or equipment such as: an x-ray system; a particle accelerator; radio isotope equipment; sonic equipment; electromagnetic application equipment; electronic power application equipment etc.).

The UE 3 may, for example, be an electronic lamp, a luminaire, a measuring instrument, an analyzer, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

The UE 3 may, for example, be a wireless-equipped personal digital assistant or related equipment (such as a wireless card or module designed for attachment to or for insertion into another electronic device (for example a personal computer, electrical measuring machine)).

The UE 3 may be a device or a part of a system that provides applications, services, and solutions described below, as to “internet of things (IoT)”, using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices or Narrow Band-IoT UE (NB-IoT UE). It will be appreciated that a UE 3 may support one or more IoT or MTC applications.

The UE 3 may be a smart phone or a wearable device (e.g. smart glasses, a smart watch, a smart ring, or a hearable device).

The UE 3 may be a car, or a connected car, or an autonomous car, or a vehicle device, or a motorcycle or V2X (Vehicle to Everything) communication module (e.g. Vehicle to Vehicle communication module, Vehicle to Infrastructure communication module, Vehicle to People communication module and Vehicle to Network communication module).

### < (R) an Node>

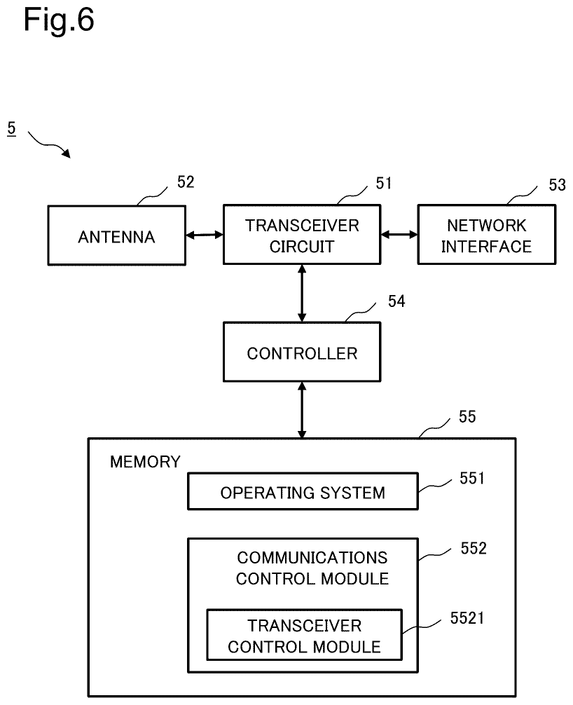

FIG. 6 is a block diagram illustrating the main components of an exemplary (R)AN node 5, for example a base station (′eNB′ in LTE, ‘gNB’ in 5G, a base station for 5G beyond, a base station for 6G). As shown, the (R)AN node 5 includes a transceiver circuit 51 which is operable to transmit signals to and to receive signals from connected UE(s) 3 via one or more antennas 52 and to transmit signals to and to receive signals from other network nodes (either directly or indirectly) via a network interface 53. A controller 54 controls the operation of the (R)AN node 5 in accordance with software stored in a memory 55. Software may be pre-installed in the memory and/or may be downloaded via the telecommunication network or from a removable data storage device (RMD), for example. The software includes, among other things, an operating system 551 and a communications control module 552 having at least a transceiver control module 5521.

The communications control module 552 (using its transceiver control sub-module) is responsible for handling (generating/sending/receiving) signalling between the (R)AN node 5 and other nodes, such as the UE 3, another (R)AN node 5, the AMF 70 and the UPF 72 (e.g. directly or indirectly). The signalling may include, for example, appropriately formatted signalling messages relating to a radio connection and a connection with the core network 7 (for a particular UE 3), and in particular, relating to connection establishment and maintenance (e.g. RRC connection establishment and other RRC messages), NG Application Protocol (NGAP) messages (i.e. messages by N2 reference point) and Xn application protocol (XnAP) messages (i.e. messages by Xn reference point), etc. Such signalling may also include, for example, broadcast information (e.g. Master Information and System information) in a sending case.

The controller 54 is also configured (by software or hardware) to handle related tasks such as, when implemented, UE mobility estimates and/or moving trajectory estimation.

The (R)AN node 5 may support the Non-Public Network (NPN), The NPN may be a Stand-alone Non-Public Network (SNPN) or a Public Network Integrated NPN (PN1-NPN).

### <System Overview of (R)AN Node 5 Based on O-RAN Architecture>

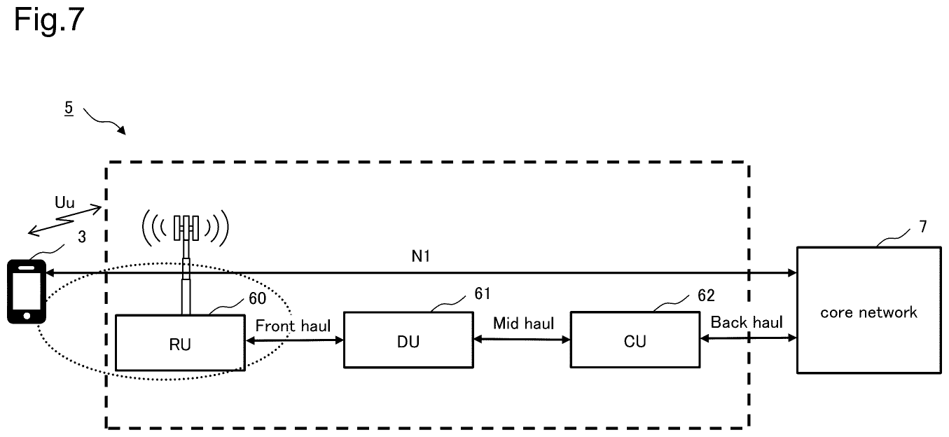

FIG. 7 schematically illustrates a (R)AN node 5 based on O-RAN architecture to which the (R)AN node 5 aspects are applicable.

The (R)AN node 5 based on O-RAN architecture represents a system overview in which the (R)AN node is split into a Radio Unit (RU) 60, Distributed Unit (DU) 61 and Centralized Unit (CU) 62. In some aspects, each unit may be combined. For example, the RU 60 can be integrated/combined with the DU 61 as an integrated/combined unit, the DU 61 can be integrated/combined with the CU 62 as another integrated/combined unit. Any functionality in the description for a unit (e.g. one of RU 60, DU 61 and CU 62) can be implemented in the integrated/combined unit above. Further, CU 62 can separate into two functional units such as CU Control plane (CP) and CU User plane (UP). The CU CP has a control plane functionality in the (R)AN node 5. The CU UP has a user plane functionality in the (R)AN node 5. Each CU CP is connected to the CU UP via an appropriate interface (such as the so-called “E1” interface and/or the like).

The UE 3 and a respective serving RU 60 are connected via an appropriate air interface (for example the so-called “Uu” interface and/or the like). Each RU 60 is connected to the DU 61 via an appropriate interface (such as the so-called “Front haul”, “Open Front haul”, “F1” interface and/or the like). Each DU 61 is connected to the CU 62 via an appropriate interface (such as the so-called “Mid haul”, “Open Mid haul”, “E2” interface and/or the like). Each CU 62 is also connected to nodes in the core network 7 (such as the so-called core network nodes) via an appropriate interface (such as the so-called “Back haul”, “Open Back haul”, “N2”/“N3” interface(s) and/or the like). In addition, a user plane part of the DU 61 can also be connected to the core network nodes 7 via an appropriate interface (such as the so-called “N3” interface(s) and/or the like).

Depending on functionality split among the RU 60, DU 61 and CU 62, each unit provides some of the functionality that is provided by the (R)AN node 5. For example, the RU 60 may provide functionalities to communicate with a UE 3 over air interface, the DU 61 may provide functionalities to support MAC layer and RLC layer, the CU 62 may provide functionalities to support PDCP layer, SDAP layer and RRC layer.

### <Radio Unit (RU)>

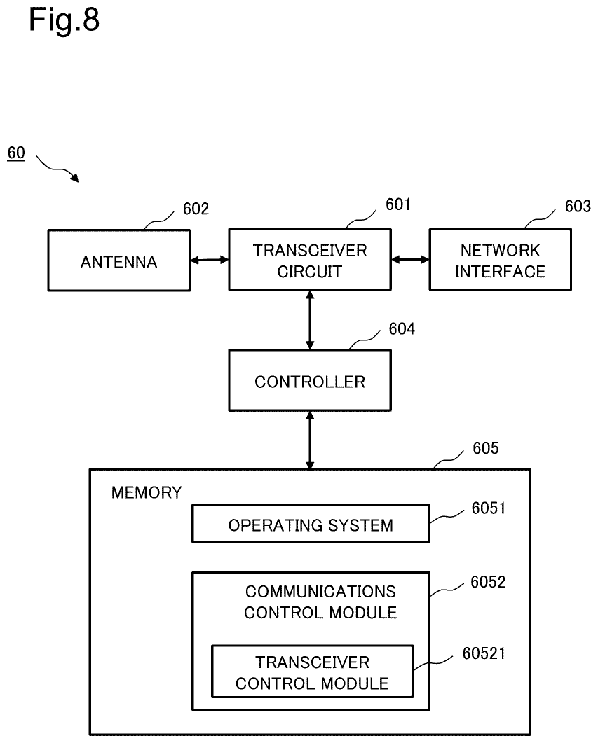

FIG. 8 is a block diagram illustrating the main components of an exemplary RU 60, for example a RU part of base station (′eNB′ in LTE, ‘gNB’ in 5G, a base station for 5G beyond, a base station for 6G). As shown, the RU 60 includes a transceiver circuit 601 which is operable to transmit signals to and to receive signals from connected UE(s) 3 via one or more antennas 602 and to transmit signals to and to receive signals from other network nodes or network unit (either directly or indirectly) via a network interface 603. A controller 604 controls the operation of the RU 60 in accordance with software stored in a memory 605. Software may be pre-installed in the memory and/or may be downloaded via the telecommunication network or from a removable data storage device (RMD), for example. The software includes, among other things, an operating system 6051 and a communications control module 6052 having at least a transceiver control module 60521.

The communications control module 6052 (using its transceiver control sub-module) is responsible for handling (generating/sending/receiving) signalling between the RU 60 and other nodes or units, such as the UE 3, another RU 60 and DU 61 (e.g. directly or indirectly). The signalling may include, for example, appropriately formatted signalling messages relating to a radio connection and a connection with the RU 60 (for a particular UE 3), and in particular, relating to MAC layer and RLC layer.

The controller 604 is also configured (by software or hardware) to handle related tasks such as, when implemented, UE mobility estimates and/or moving trajectory estimation.

The RU 60 may support the Non-Public Network (NPN), The NPN may be a Stand-alone Non-Public Network (SNPN) or a Public Network Integrated NPN (PN1-NPN).

As described above, the RU 60 can be integrated/combined with the DU 61 as an integrated/combined unit. Any functionality in the description for the RU 60 can be implemented in the integrated/combined unit above.

### <Distributed Unit (DU)>

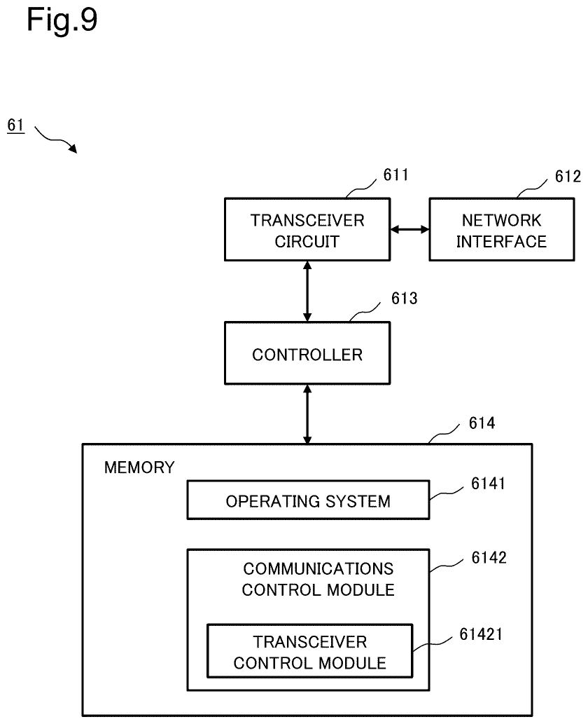

FIG. 9 is a block diagram illustrating the main components of an exemplary DU 61, for example a DU part of a base station (′eNB′ in LTE, ‘gNB’ in 5G, a base station for 5G beyond, a base station for 6G). As shown, the apparatus includes a transceiver circuit 611 which is operable to transmit signals to and to receive signals from other nodes or units (including the RU 60) via a network interface 612. A controller 613 controls the operation of the DU 61 in accordance with software stored in a memory 614. Software may be pre-installed in the memory 614 and/or may be downloaded via the telecommunication network or from a removable data storage device (RMD), for example. The software includes, among other things, an operating system 6141 and a communications control module 6142 having at least a transceiver control module 61421. The communications control module 6142 (using its transceiver control module 61421 is responsible for handling (generating/sending/receiving) signalling between the DU 61 and other nodes or units, such as the RU 60 and other nodes and units.

The DU 61 may support the Non-Public Network (NPN), The NPN may be a Stand-alone Non-Public Network (SNPN) or a Public Network Integrated NPN (PN1-NPN).

As described above, the RU 60 can be integrated/combined with the DU 61 or CU 62 as an integrated/combined unit. Any functionality in the description for DU 61 can be implemented in one of the integrated/combined unit above.

### <Centralized Unit (CU)>

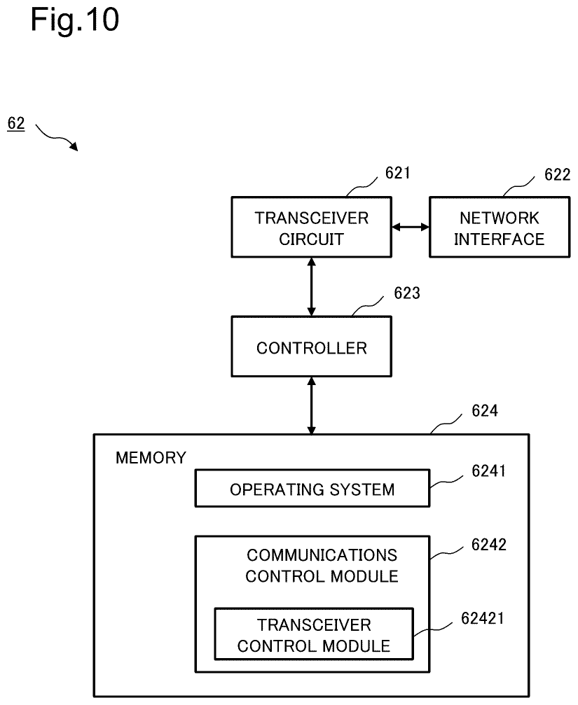

FIG. 10 is a block diagram illustrating the main components of an exemplary CU 62, for example a CU part of base station (′eNB′ in LTE, ‘gNB’ in 5G, a base station for 5G beyond, a base station for 6G). As shown, the apparatus includes a transceiver circuit 621 which is operable to transmit signals to and to receive signals from other nodes or units (including the DU 61) via a network interface 622. A controller 623 controls the operation of the CU 62 in accordance with software stored in a memory 624. Software may be pre-installed in the memory 624 and/or may be downloaded via the telecommunication network or from a removable data storage device (RMD), for example. The software includes, among other things, an operating system 6241 and a communications control module 6242 having at least a transceiver control module 62421. The communications control module 6242 (using its transceiver control module 62421 is responsible for handling (generating/sending/receiving) signalling between the CU 62 and other nodes or units, such as the DU 61 and other nodes and units.

The CU 62 may support the Non-Public Network (NPN), The NPN may be a Stand-alone Non-Public Network (SNPN) or a Public Network Integrated NPN (PN1-NPN).

As described above, the CU 62 can be integrated/combined with the DU 61 as an integrated/combined unit. Any functionality in the description for the CU 62 can be implemented in the integrated/combined unit above.

### <AMF>

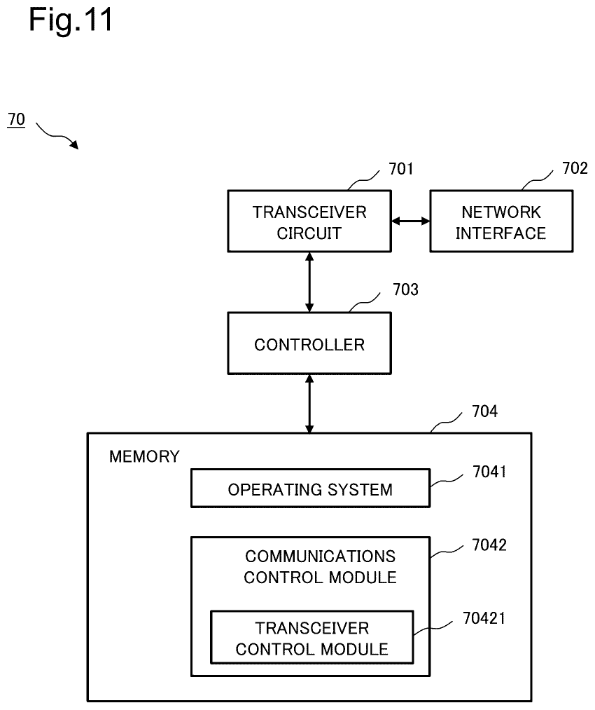

FIG. 11 is a block diagram illustrating the main components of the AMF 70. As shown, the apparatus includes a transceiver circuit 701 which is operable to transmit signals to and to receive signals from other nodes (including the UE 3, the NSSAAF 76) via a network interface 702. A controller 703 controls the operation of the AMF 70 in accordance with software stored in a memory 704. Software may be pre-installed in the memory 704 and/or may be downloaded via the telecommunication network or from a removable data storage device (RMD), for example. The software includes, among other things, an operating system 7041 and a communications control module 7042 having at least a transceiver control module 70421. The communications control module 7042 (using its transceiver control module 70421 is responsible for handling (generating/sending/receiving) signalling between the AMF 70 and other nodes, such as the UE 3 (e.g. via the (R)AN node 5) and other core network nodes (including core network nodes in the HPLMN of the UE 3 when the UE 3 is roaming-in. Such signalling may include, for example, appropriately formatted signalling messages (e.g. a registration request message and associated response messages) relating to access and mobility management procedures (for the UE 3).

The AMF 70 may support the Non-Public Network (NPN), The NPN may be a Stand-alone Non-Public Network (SNPN) or a Public Network Integrated NPN (PN1-NPN). An AMF 7001 and an AMF 7002 may have same components to the AMF 70.

### <PCF>

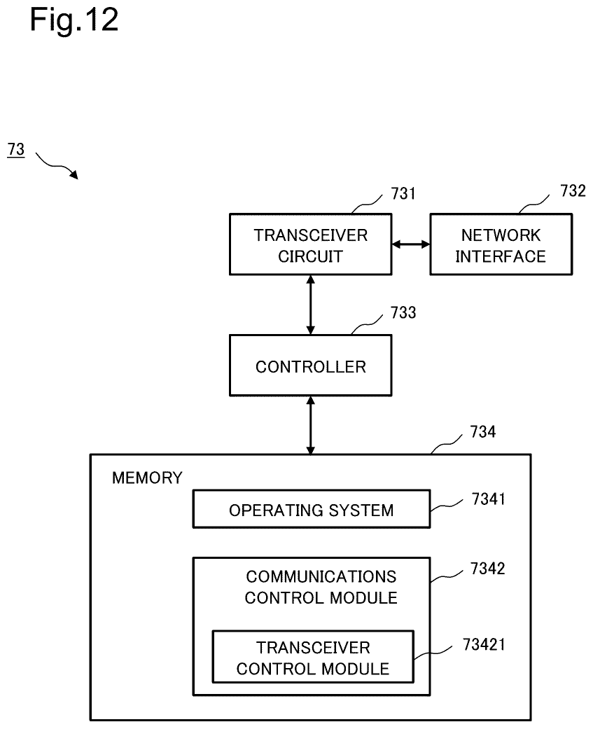

FIG. 12 is a block diagram illustrating the main components of the PCF 73. As shown, the apparatus includes a transceiver circuit 731 which is operable to transmit signals to and to receive signals from other nodes (including the AMF 70) via a network interface 732. A controller 733 controls the operation of the PCF 73 in accordance with software stored in a memory 734. Software may be pre-installed in the memory 734 and/or may be downloaded via the telecommunication network or from a removable data storage device (e.g. a removable memory device (RMD)), for example. The software includes, among other things, an operating system 7341 and a communications control module 7342 having at least a transceiver control module 73421. The communications control module 7342 (using its transceiver control module 73421 is responsible for handling (generating/sending/receiving) signalling between the PCF 73 and other nodes, such as the AMF 70 and other core network nodes (including core network nodes in the HPLMN of the UE 3 when the UE 3 is roaming-in. Such signalling may include, for example, appropriately formatted signalling messages (e.g. a HTTP restful methods based on the service based interfaces) relating to policy management procedures (for the UE 3).

The PCF 73 may support the Non-Public Network (NPN), The NPN may be a Stand-alone Non-Public Network (SNPN) or a Public Network Integrated NPN (PN1-NPN). A PCF 7301 and a PCF 7302 may have same components to the PCF 73.

### <AUSF>

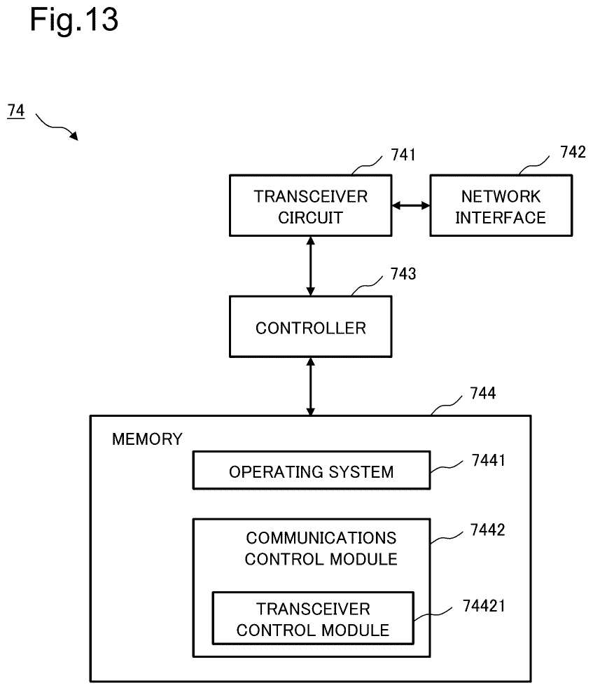

FIG. 13 is a block diagram illustrating the main components of the AUSF 74. As shown, the apparatus includes a transceiver circuit 741 which is operable to transmit signals to and to receive signals from other nodes (including the UDM 75) via a network interface 742. A controller 743 controls the operation of the AUSF 74 in accordance with software stored in a memory 744. Software may be pre-installed in the memory 744 and/or may be downloaded via the telecommunication network or from a removable data storage device (e.g. a removable memory device (RMD)), for example. The software includes, among other things, an operating system 7441 and a communications control module 7442 having at least a transceiver control module 74421. The communications control module 7442 (using its transceiver control module 74421 is responsible for handling (generating/sending/receiving) signalling between the AUSF 74 and other nodes, such as the AMF 70 and other core network nodes (including core network nodes in the HPLMN of the UE 3 when the UE 3 is roaming-in. Such signalling may include, for example, appropriately formatted signalling messages (e.g. a HTTP restful methods based on the service based interfaces) relating to policy management procedures (for the UE 3).

The AUSF 74 may support the Non-Public Network (NPN), The NPN may be a Stand-alone Non-Public Network (SNPN) or a Public Network Integrated NPN (PN1-NPN).

### <UDM>

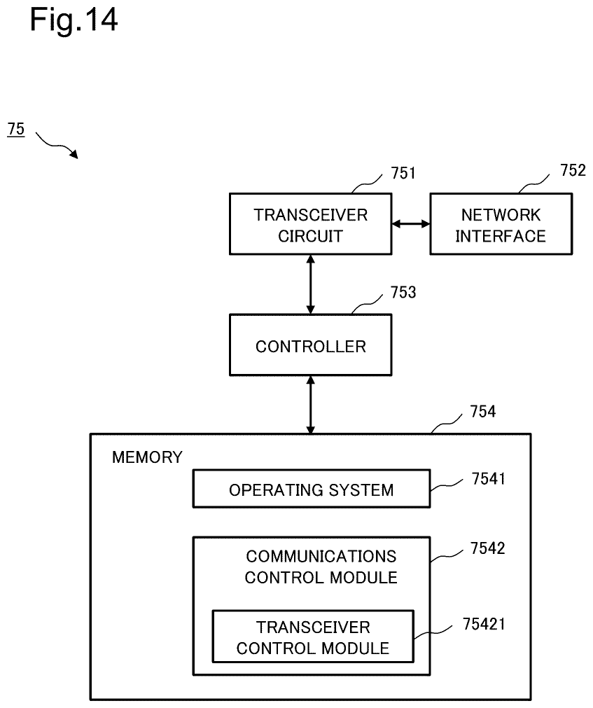

FIG. 14 is a block diagram illustrating the main components of the UDM 75. As shown, the apparatus includes a transceiver circuit 751 which is operable to transmit signals to and to receive signals from other nodes (including the AMF 70) via a network interface 752. A controller 753 controls the operation of the UDM 75 in accordance with software stored in a memory 754. Software may be pre-installed in the memory 754 and/or may be downloaded via the telecommunication network or from a removable data storage device (RMD), for example. The software includes, among other things, an operating system 7541 and a communications control module 7542 having at least a transceiver control module 75421. The communications control module 7542 (using its transceiver control module 75421 is responsible for handling (generating/sending/receiving) signalling between the UDM 75 and other nodes, such as the AMF 70 and other core network nodes (including core network nodes in the VPLMN of the UE 3 when the UE 3 is roaming-out. Such signalling may include, for example, appropriately formatted signalling messages (e.g. a HTTP restful methods based on the service based interfaces) relating to mobility management procedures (for the UE 3).

The UDM 75 may support the Non-Public Network (NPN), The NPN may be a Stand-alone Non-Public Network (SNPN) or a Public Network Integrated NPN (PN1-NPN).

### <NSSAAF>

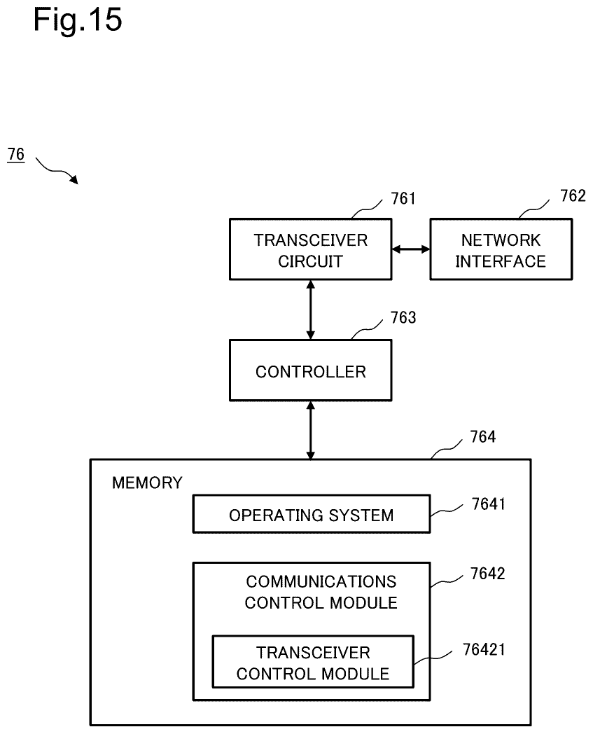

FIG. 15 is a block diagram illustrating the main components of the NSSAAF 76. As shown, the apparatus includes a transceiver circuit 761 which is operable to transmit signals to and to receive signals from other nodes (including the AMF 70, an AAA Proxy (AAA-P)) via a network interface 762. A controller 763 controls the operation of the NSSAAF 76 in accordance with software stored in a memory 764. Software may be pre-installed in the memory 764 and/or may be downloaded via the telecommunication network or from a removable data storage device (RMD), for example. The software includes, among other things, an operating system 7641 and a communications control module 7642 having at least a transceiver control module 76421. The communications control module 7642 (using its transceiver control module 76421 is responsible for handling (generating/sending/receiving) signalling between the NSSAAF 76 and other nodes, such as the AMF 70 and other core network nodes (including core network nodes in the VPLMN of the UE 3 when the UE 3 is roaming-out. Such signalling may include, for example, appropriately formatted signalling messages (e.g. a HTTP restful methods based on the service based interfaces) relating to mobility management procedures (for the UE 3).

The NSSAAF 76 may support the Non-Public Network (NPN), The NPN may be a Stand-alone Non-Public Network (SNPN) or a Public Network Integrated NPN (PN1-NPN).

The whole or part of the example Aspects disclosed above can be described as, but not limited to, the following.

### 5.5.1.2.2 Initial Registration Initiation

The subset of configured NSSAI provided in the requested NSSAI consists of one or more S-NSSAIs in the configured NSSAI applicable to the current PLMN, if the S-NSSAI is neither in the rejected NSSAI f nor associated to the S-NSSAI(s) in the rejected NSSAI. In addition, if the NSSRG information is available, the subset of configured NSSAI provided in the requested NSSAI shall be associated with at least one common NSSRG value. If the UE has pending NSSAI, the subset of configured NSSAI provided in the requested NSSAI and pending NSSAI shall be associated with at least one common NSSRG value. If the UE has already an allowed NSSAI for the other access, all the S-NSSAI(s) in the requested NSSAI for the current access shall share at least an NSSRG value common to all the S-NSSAI(s) of the allowed NSSAI for the other access. If the UE is simultaneously performing the registration procedure on the other access, the UE shall include S-NSSAIs that share at least a common NSSRG value across all access types.

### 5.5.1.2.3 5GMM Common Procedure Initiation

The AMF may include a new configured NSSAI for the current PLMN in the REGISTRATION ACCEPT message if:
a) the REGISTRATION REQUEST message did not include the requested NSSAI and the initial registration request is not for onboarding services in SNPN;
b) the REGISTRATION REQUEST message included the requested NSSAI containing an S-NSSAI that is not valid in the serving PLMN;
c) the REGISTRATION REQUEST message included the requested NSSAI containing S-NSSAI(s) with incorrect mapped S-NSSAI(s);
d) the REGISTRATION REQUEST message included the Network slicing indication IE with the Default configured NSSAI indication bit set to “Requested NSSAI created from default configured NSSAI”; or
e) any two S-NSSAIs of the requested NSSAI in the REGISTRATION REQUEST message are not associated with any common NSSRG value.
f) the UE has pending NSSAI then S-NSSAIs of the requested NSSAI in the REGISTRATION REQUEST message and the pending NSSAI are not associated with common NSSRG value.
g) the UE has already an allowed NSSAI for the other access, then the S-NSSAIs of the requested NSSAI in the REGISTRATION REQUEST message over the current access and the allowed NSSAI are not associated with common NSSRG value

### 5.5.1.3.2 Mobility and Periodic Registration Update Initiation

The subset of configured NSSAI provided in the requested NSSAI consists of one or more S-NSSAIs in the configured NSSAI applicable to this PLMN, if the S-NSSAI is neither in the rejected NSSAI nor associated to the S-NSSAI(s) in the rejected NSSAI. In addition, if the NSSRG information is available, the subset of configured NSSAI provided in the requested NSSAI shall be associated with at least one common NSSRG value. If the UE has pending NSSAI, the subset of configured NSSAI provided in the requested NSSAI and pending NSSAI shall be associated with at least one common NSSRG value. If the UE has already an allowed NSSAI for the other access, all the S-NSSAI(s) in the requested NSSAI for the current access shall share at least an NSSRG value common to all the S-NSSAI(s) of the allowed NSSAI for the other access. If the UE is simultaneously performing the registration procedure on the other access, the UE shall include S-NSSAIs that share at least a common NSSRG value across all access types.

### 5.5.1.3.3 5GMM Common Procedure Initiation

The AMF may include a new configured NSSAI for the current PLMN in the REGISTRATION ACCEPT message if:
a) the REGISTRATION REQUEST message did not include a requested NSSAI and the UE is not registered for onboarding services in SNPN;
b) the REGISTRATION REQUEST message included a requested NSSAI containing an S-NSSAI that is not valid in the serving PLMN;
c) the REGISTRATION REQUEST message included a requested NSSAI containing an S-NSSAI with incorrect d) the REGISTRATION REQUEST message included the Network slicing indication IE with the Default configured NSSAI indication bit set to “Requested NSSAI created from default configured NSSAI”;
e) the REGISTRATION REQUEST message included the requested mapped NSSAI; or
f) any two S-NSSAIs of the requested NSSAI in the REGISTRATION REQUEST message are not associated with any common NSSRG value.
f) the UE has pending NSSAI then S-NSSAIs of the requested NSSAI in the REGISTRATION REQUEST message and the pending NSSAI are not associated with common NSSRG value.
g) the UE has already an allowed NSSAI for the other access, then the S-NSSAIs of the requested NSSAI in the REGISTRATION REQUEST message over the current access and the allowed NSSAI are not associated with common NSSRG value

### <Modifications and Alternatives>

Detailed aspects have been described above. As those skilled in the art will appreciate, a number of modifications and alternatives can be made to the above aspects whilst still benefiting from the disclosures embodied therein. By way of illustration only a number of these alternatives and modifications will now be described.

In the above description, the UE 3 and the network apparatus are described for ease of understanding as having a number of discrete modules (such as the communication control modules). Whilst these modules may be provided in this way for certain applications, for example where an existing system has been modified to implement the disclosure, in other applications, for example in systems designed with the inventive features in mind from the outset, these modules may be built into the overall operating system or code and so these modules may not be discernible as discrete entities. These modules may also be implemented in software, hardware, firmware or a mix of these.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like.

In the above aspects, a number of software modules were described. As those skilled in the art will appreciate, the software modules may be provided in compiled or un-compiled form and may be supplied to the UE 3 and the network apparatus as a signal over a computer network, or on a recording medium. Further, the functionality performed by part or all of this software may be performed using one or more dedicated hardware circuits. However, the use of software modules is preferred as it facilitates the updating of the UE 3 and the network apparatus in order to update their functionalities.

In the above aspects, a 3GPP radio communications (radio access) technology is used. However, any other radio communications technology (e.g. WLAN, Wi-Fi, WiMAX, Bluetooth, etc.) and other fix line communications technology (e.g. BBF Access, Cable Access, optical access, etc.) may also be used in accordance with the above aspects.

Items of user equipment might include, for example, communication devices such as mobile telephones, smartphones, user equipment, personal digital assistants, laptop/tablet computers, web browsers, e-book readers and/or the like. Such mobile (or even generally stationary) devices are typically operated by a user, although it is also possible to connect so-called ‘Internet of Things’ (IoT) devices and similar machine-type communication (MTC) devices to the network. For simplicity, the present application refers to mobile devices (or UEs) in the description but it will be appreciated that the technology described can be implemented on any communication devices (mobile and/or generally stationary) that can connect to a communications network for sending/receiving data, regardless of whether such communication devices are controlled by human input or software instructions stored in memory.

Various other modifications will be apparent to those skilled in the art and will not be described in further detail here.

As will be appreciated by one of skill in the art, the present disclosure may be embodied as a method, and system. Accordingly, the present disclosure may take the form of an entirely hardware embodiment, a software embodiment or an embodiment combining software and hardware aspects.

It will be understood that each block of the block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. A general-purpose processor may be a microprocessor, but in the alternative, the processor may be any conventional processor, controller, microcontroller, or state machine. A processor may also be implemented as a combination of computing devices, e.g., a plurality of microprocessors, one or more microprocessors, or any other such configuration.

The methods or algorithms described in connection with the examples disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor. The processor and the storage medium may reside in an ASIC.

The previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

While the disclosure has been particularly shown and described with reference to exemplary Aspects thereof, the disclosure is not limited to these Aspects. It will be understood by those of ordinary skill in the art that various changes in form and details may be made therein without departing from the spirit and scope of the present disclosure as defined by this document. For example, the Aspects above are not limited to 5GS, and the Aspects are also applicable to communication system other than 5GS (e.g., 6G system, 5G beyond system).

### <Supplementary Notes>

The whole or part of the example Aspects disclosed above can be described as, but not limited to, the following supplementary notes.

supplementary note 1. A method of a user equipment (UE), the method comprising:
receiving a message including Pending Network Slice Selection Assistance Information (NSSAI),
wherein the Pending NSSAI includes first Single Network Slice Selection Assistance Information (S-NSSAI);
checking whether the first S-NSSAI and second S-NSSAI are associated with at least one common Network Slice Simultaneous Registration Group (NSSRG) value in a case where registration procedure using the second S-NSSAI is triggered; and
sending a registration request message including the second S-NSSAI in a case where the first S-NSSAI and the second S-NSSAI are associated with the at least one common NSSRG value.

supplementary note 2. A method of a communication apparatus, the method comprising:
sending a first message including Pending Network Slice Selection Assistance Information (NSSAI),
wherein the Pending NSSAI includes first Single Network Slice Selection Assistance Information (S-NSSAI);
receiving a registration request message including Requested NSSAI,
wherein the Requested NSSAI includes second S-NSSAI;
checking whether the first S-NSSAI and the second S-NSSAI are associated with at least one common Network Slice Simultaneous Registration Group (NSSRG) value; and
sending a second message including Configured NSSAI in case where the first S-NSSAI and the second S-NSSAI are not associated with the at least one common NSSRG value.

supplementary note 3. A user equipment (UE) comprising:
means for receiving a message including Pending Network Slice Selection Assistance Information (NSSAI),
wherein the Pending NSSAI includes first Single Network Slice Selection Assistance Information (S-NSSAI);
means for checking whether the first S-NSSAI and second S-NSSAI are associated with at least one common Network Slice Simultaneous Registration Group (NSSRG) value in a case where registration procedure using the second S-NSSAI is triggered; and
means for sending a registration request message including the second S-NSSAI in a case where the first S-NSSAI and the second S-NSSAI are associated with the at least one common NSSRG value.

supplementary note 4. A communication apparatus comprising:
means for sending a first message including Pending Network Slice Selection Assistance Information (NSSAI),
wherein the Pending NSSAI includes first Single Network Slice Selection Assistance Information (S-NSSAI);
means for receiving a registration request message including Requested NSSAI,
wherein the Requested NSSAI includes second S-NSSAI;
means for checking whether the first S-NSSAI and the second S-NSSAI are associated with at least one common Network Slice Simultaneous Registration Group (NSSRG) value; and
means for sending a second message including Configured NSSAI in case where the first S-NSSAI and the second S-NSSAI are not associated with the at least one common NSSRG value.

supplementary note 5. A method of a communication apparatus, the method comprising:
performing, over one access, registration procedure using first Single Network Slice Selection Assistance Information (S-NSSAI);
receiving, over another access, a registration request message including second S-NSSAI;
checking whether the first S-NSSAI and the second S-NSSAI are associated with at least one common Network Slice Simultaneous Registration Group (NSSRG) value; and
sending a message including Configured NSSAI in case where the first S-NSSAI and the second S-NSSAI are not associated with the at least one common NSSRG value.

supplementary note 6. A method of a user equipment (UE), the method comprising:
performing, over one access, registration procedure using first Single Network Slice Selection Assistance Information (S-NSSAI);
sending, over another access, a registration request message including second S-NSSAI; and
receiving a message including Configured NSSAI in case where the first S-NSSAI and the second S-NSSAI are not associated with at least one common Network Slice Simultaneous Registration Group (NSSRG) value.

supplementary note 7. A communication apparatus comprising:
means for performing, over one access, registration procedure using first Single Network Slice Selection Assistance Information (S-NSSAI);
means for receiving, over another access, a registration request message including second S-NSSAI;
means for checking whether the first S-NSSAI and the second S-NSSAI are associated with at least one common Network Slice Simultaneous Registration Group (NSSRG) value; and
means for sending a message including Configured NSSAI in case where the first S-NSSAI and the second S-NSSAI are not associated with the at least one common NSSRG value.

supplementary note 8. A user equipment (UE) comprising:
means for performing, over one access, registration procedure using first Single Network Slice Selection Assistance Information (S-NSSAI);
means for sending, over another access, a registration request message including second S-NSSAI; and
means for receiving a message including Configured NSSAI in case where the first S-NSSAI and the second S-NSSAI are not associated with at least one common Network Slice Simultaneous Registration Group (NSSRG) value.
   <Supplementary notes 2>

supplementary note 1. A method of a user equipment (UE), the method comprising:
communicating with a communication apparatus; and
sending a Registration Request message,
wherein the Registration Request message includes Requested Network Slice Selection Assistance Information (NSSAI),
wherein the Requested NSSAI includes first Single Network Slice Selection Assistance Information (S-NSSAI), and
wherein the first S-NSSAI and second S-NSSAI in Pending NSSAI are associated with at least one common Network Slice Simultaneous Registration Group (NSSRG) value.

supplementary note 2. The method according to supplementary note 1, further comprising:
receiving the Pending NSSAI from the communication apparatus.

supplementary note 3. A user equipment (UE) comprising:
means for communicating with a communication apparatus; and
means for sending a Registration Request message,
wherein the Registration Request message includes Requested Network Slice Selection Assistance Information (NSSAI),
wherein the Requested NSSAI includes first Single Network Slice Selection Assistance Information (S-NSSAI), and
wherein the first S-NSSAI and second S-NSSAI in Pending NSSAI are associated with at least one common Network Slice Simultaneous Registration Group (NSSRG) value.

supplementary note 4. The UE according to supplementary note 3, further comprising:
means for receiving the Pending NSSAI from the communication apparatus.

### Supplementary Note 5.

A method of a communication apparatus, the method comprising:
communicating with a user equipment (UE); and
sending a message,
wherein the message includes Allowed Network Slice Selection Assistance Information (NSSAI),
wherein the Allowed NSSAI includes first Single Network Slice Selection Assistance Information (S-NSSAI), and
wherein the first S-NSSAI and second S-NSSAI in Pending NSSAI are associated with at least one common Network Slice Simultaneous Registration Group (NSSRG) value.

### Supplementary Note 6.

The method according to supplementary note 5,
wherein the message includes the Pending NSSAI, and
wherein the message is a Registration Accept message.

### Supplementary Note 7.

The method according to supplementary note 5 or 6,
wherein the communication apparatus has the Pending NSSAI.

### Supplementary Note 8.

A communication apparatus comprising:
means for communicating with a user equipment (UE); and
means for sending a message,
wherein the message includes Allowed Network Slice Selection Assistance Information (NSSAI),
wherein the Allowed NSSAI includes first Single Network Slice Selection Assistance Information (S-NSSAI), and
wherein the first S-NSSAI and second S-NSSAI in Pending NSSAI are associated with at least one common Network Slice Simultaneous Registration Group (NSSRG) value.

### Supplementary Note 9.

The communication apparatus according to supplementary note 8,
wherein the message includes the Pending NSSAI, and
wherein the message is a Registration Accept message.

### Supplementary Note 10.

The communication apparatus according to supplementary note 8 or 9,
wherein the communication apparatus has the Pending NSSAI.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Indian provisional patent application No. 202211016659, filed on Mar. 24, 2022, the disclosure of which is incorporated herein in its entirety by reference.

### REFERENCE SIGNS LIST

1 telecommunication system
3 UE
5 (R)AN node
7 core network
20 data network
31 transceiver circuit
32 antenna
33 controller
34 user interface
35 USIM
36 memory
51 transceiver circuit
52 antenna
53 network interface
54 controller
55 memory
60 RU
61 DU
62 CU
70 AMF
71 SMF
72 UPF
73 PCF
74 AUSF
75 UDM
76 NSSAAF
361 operating system
362 communications control module
501 3GPP access
502 3GPP access
551 operating system
552 communications control module
601 transceiver circuit
602 antenna
603 network interface
604 controller
605 memory
611 transceiver circuit
612 network interface
613 controller
614 memory
621 transceiver circuit
622 network interface
623 controller
624 memory
701 transceiver circuit
702 network interface
703 controller
704 memory
731 transceiver circuit
732 network interface
733 controller
734 memory
741 transceiver circuit
742 network interface
743 controller
744 memory
751 transceiver circuit
752 network interface
753 controller
754 memory
761 transceiver circuit
762 network interface
763 controller
764 memory
3621 transceiver control module
5521 transceiver control module
6051 operating system
6052 communications control module
6141 operating system
6142 communications control module
6241 operating system
6242 communications control module
7041 operating system
7042 communications control module
7341 operating system
7342 communications control module
7441 operating system
7442 communications control module
7541 operating system
7542 communications control module
7641 operating system
7642 communications control module
60521 transceiver control module
61421 transceiver control module
62421 transceiver control module
70421 transceiver control module
73421 transceiver control module
74421 transceiver control module
75421 transceiver control module
76421 transceiver control module

What is claimed is:

1. A method of a user equipment (UE), the method comprising:
communicating with a communication apparatus; and
sending a Registration Request message,
wherein the Registration Request message includes Requested Network Slice Selection Assistance Information (NSSAI),
wherein the Requested NSSAI includes first Single Network Slice Selection Assistance Information (S-NSSAI), and
wherein the first S-NSSAI and second S-NSSAI in Pending NSSAI are associated with at least one common Network Slice Simultaneous Registration Group (NSSRG) value.

2. The method according to claim 1, further comprising:
receiving the Pending NSSAI from the communication apparatus.

3. A user equipment (UE) comprising:
at least one memory; and
at least one hardware processor coupled to the at least one memory,
wherein the at least one hardware processor is configured to:
send a Registration Request message,
wherein the Registration Request message includes Requested Network Slice Selection Assistance Information (NSSAI),
wherein the Requested NSSAI includes first Single Network Slice Selection Assistance Information (S-NSSAI), and
wherein the first S-NSSAI and second S-NSSAI in Pending NSSAI are associated with at least one common Network Slice Simultaneous Registration Group (NSSRG) value.

4. (canceled)

5. A method of a communication apparatus, the method comprising:
communicating with a user equipment (UE); and
sending a message,
wherein the message includes Allowed Network Slice Selection Assistance Information (NSSAI),
wherein the Allowed NSSAI includes first Single Network Slice Selection Assistance Information (S-NSSAI), and
wherein the first S-NSSAI and second S-NSSAI in Pending NSSAI are associated with at least one common Network Slice Simultaneous Registration Group (NSSRG) value.

6. The method according to claim 5,
wherein the message includes the Pending NSSAI, and
wherein the message is a Registration Accept message.

7. The method according to claim 5,
wherein the communication apparatus has the Pending NSSAI.

8. A communication apparatus comprising:
at least one memory; and
at least one hardware processor coupled to the at least one memory,
wherein the at least one hardware processor is configured to:
send a message,
wherein the message includes Allowed Network Slice Selection Assistance Information (NSSAI),
wherein the Allowed NSSAI includes first Single Network Slice Selection Assistance Information (S-NSSAI), and
wherein the first S-NSSAI and second S-NSSAI in Pending NSSAI are associated with at least one common Network Slice Simultaneous Registration Group (NSSRG) value.

9-12. (canceled)
